(19) United States
(12) Patent Application Publication
(10) Pub. No.: US 2025/0224546 A1
(43) Pub. Date: Jul. 10, 2025

(54) LIQUID CRYSTAL DIFFRACTION ELEMENT

(71) Applicant: FUJIFILM Corporation, Tokyo (JP)

(72) Inventors: Takashi YONEMOTO, Minamiashigara-shi (JP); Hiroshi SATO, Minamiashigara-shi (JP); Takeharu TANI, Minamiashigara-shi (JP)

(73) Assignee: FUJIFILM Corporation, Tokyo (JP)

(21) Appl. No.: 19/093,420

(22) Filed: Mar. 28, 2025

Related U.S. Application Data
(63) Continuation of application No. PCT/JP2023/035194, filed on Sep. 27, 2023.

(30) Foreign Application Priority Data
Sep. 30, 2022 (JP) 2022-158940

(51) Int. Cl. G02B 5/18; G02F 1/1337

(52) U.S. Cl. CPC G02B 5/18; G02F 1/1337

(57) ABSTRACT

An object is to provide a liquid crystal diffraction element which can convert a zeroth-order ray into polarized light different from an incidence ray. The object is achieved by an optically anisotropic layer having a liquid crystal alignment pattern in which an orientation of an optical axis changes while continuously rotating in one in-plane direction, in which, in a case where a main surface of the optically anisotropic layer is observed with an optical microscope under crossed nicols such that a dark line thicker than dark lines on both adjacent sides is randomly selected, and 80 continuous dark lines are selected with the randomly selected dark line as a first dark line, a width of a dark line at an even-numbered position is narrower than a width of a dark line at an odd-numbered position, which is adjacent to the dark line at an even-numbered position.

### CROSS-REFERENCE TO RELATED APPLICATIONS

This application is a Continuation of PCT International Application No. PCT/JP2023/035194 filed on Sep. 27, 2023, which claims priority under 35 U.S.C. § 119(a) to Japanese Patent Application No. 2022-158940 filed on Sep. 30, 2022. The above applications are hereby expressly incorporated by reference, in their entirety, into the present application.

### BACKGROUND OF THE INVENTION

### 1. Field of the Invention

The present invention relates to a liquid crystal diffraction element which diffracts incidence ray.

### 2. Description of the Related Art

A liquid crystal diffraction element which diffracts incidence ray and allows transmission of the diffracted light has been known.

As the liquid crystal diffraction element, a liquid crystal diffraction element including an optically anisotropic layer which is formed of a liquid crystal composition containing a liquid crystal compound has been known.

For example, JP2012-505430A discloses a liquid crystal device including a first polarization diffraction grating which is configured to polarize and diffract an incidence ray to form a first beam and a second beam having different polarizations and different propagation directions, a liquid crystal layer which is configured to receive the first beam and the second beam from the first polarization diffraction grating and to be switched between a first state in which the polarization of each of the first beam and the second beam passing through the inside of the liquid crystal layer is not substantially changed and a second state in which the polarization of each of the first beam and the second beam passing through the inside of the liquid crystal layer is changed, and a second polarization diffraction grating which is configured to receive the first beam and the second beam from the liquid crystal layer, to perform polarization analysis on the first beam and the second beam, and to change propagation directions of the first beam and the second beam according to a state of the liquid crystal layer.

The first polarization diffraction grating and the second polarization diffraction grating in the liquid crystal device are liquid crystal diffraction elements.

The liquid crystal diffraction element has a liquid crystal alignment pattern in which an orientation of an optical axis derived from a liquid crystal compound changes while continuously rotating in at least one in-plane direction.

The liquid crystal diffraction element having such a liquid crystal alignment pattern can diffract incident light at an angle depending on a wavelength. In addition, in a case where the alignment pattern of the liquid crystal compound is uniform, light having the same wavelength can be diffracted at a uniform angle irrespective of incidence positions.

By such characteristics, the liquid crystal diffraction element can be used for various applications such as augmented reality (AR) glasses and a head-mounted display which displays a virtual reality (VR) image.

### SUMMARY OF THE INVENTION

The liquid crystal diffraction element having the liquid crystal alignment pattern diffracts dextrorotatory circularly polarized light and levorotatory circularly polarized light in opposite directions depending on a turning direction of a circularly polarized light component of incidence ray.

In addition, light diffracted by the liquid crystal diffraction element has an opposite turning direction. That is, the dextrorotatory circularly polarized light is converted into the levorotatory circularly polarized light, and the levorotatory circularly polarized light is converted into the dextrorotatory circularly polarized light.

Furthermore, light which is not diffracted by the liquid crystal diffraction element, that is, zeroth-order ray transmits through the liquid crystal diffraction element in the original polarization state, without being converted into another polarization state.

Here, in a device using the liquid crystal diffraction element, the zeroth-order ray becomes stray light, which causes a decrease in image quality or the like.

For example, in an image display apparatus using the liquid crystal diffraction element, in a case where levorotatory circularly polarized light (levorotatory circularly polarized light component) diffracted by the liquid crystal diffraction element is used for image display by incidence of unpolarized light, levorotatory circularly polarized light as first-order ray of a dextrorotatory circularly polarized light component of the incident unpolarized light is used as light for image display.

In this case, a zeroth-order ray of the dextrorotatory circularly polarized light component of the incidence ray transmits through the liquid crystal diffraction element as dextrorotatory circularly polarized light, and the levorotatory circularly polarized light component of the incidence ray is diffracted and converted into the dextrorotatory circularly polarized light. Accordingly, the dextrorotatory circularly polarized light can be removed by providing a circularly polarizing plate which absorbs the right circularly polarized light downstream of the liquid crystal diffraction element.

However, the zeroth-order ray of the levorotatory circularly polarized light component of the incidence ray is the levorotatory circularly polarized light, and cannot be removed by the circularly polarizing plate which absorbs the dextrorotatory circularly polarized light. As a result, the levorotatory circularly polarized light as the zeroth-order ray is transmitted through the circularly polarizing plate together with the levorotatory circularly polarized light as the first-order ray of the dextrorotatory circularly polarized light used as the display image, is observed as stray light, and is one of the causes of the decrease in image quality.

An object of the present invention is to solve the above-described problem of the related art, and to provide a liquid crystal diffraction element which can convert a zeroth-order ray transmitted without being diffracted into polarized light different from an incidence ray, and can remove a zeroth-order ray in an image display apparatus or the like, in which, for example, the zeroth-order ray becomes stray light.

In order to solve the problems, the present invention has the following configuration.

[1] A liquid crystal diffraction element comprising:
an optically anisotropic layer formed of a liquid crystal composition containing a liquid crystal compound;
in which the optically anisotropic layer has a liquid crystal alignment pattern in which an orientation of an optical axis derived from the liquid crystal compound changes while continuously rotating in at least one in-plane direction, and
in a case where a length in the liquid crystal alignment pattern, over which the orientation of the optical axis derived from the liquid crystal compound rotates by 180° in a plane, is set as a single period, an average period in 50 periods from a single period having a longest length along the one direction is defined as Λa, a main surface of the optically anisotropic layer is observed with an optical microscope under crossed nicols in a region having a single period equal to or less than the average period Λa, in a state in which the optically anisotropic layer is disposed such that an absorption axis of a polarizer constituting the crossed nicols is parallel to the one direction, and using the absorption axis of the polarizer, parallel to the one direction, as an observation direction, in observed bright lines and dark lines, a dark line having a width wider than a width of dark lines on both adjacent sides is randomly selected, and 80 continuous dark lines are selected with the randomly selected dark line as a first dark line,
   in the selected 80 continuous dark lines in the observation direction, a width of a dark line at an even-numbered position is narrower than a width of a dark line at an odd-numbered position, which is adjacent to the dark line at an even-numbered position, and a width of a dark line at an odd-numbered position is wider than a width of a dark line at an even-numbered position, which is adjacent to the dark line at an odd-numbered position.

[2] The liquid crystal diffraction element according to [1],
in which the selected 80 continuous dark lines satisfy the following expression,

[average of widths of dark lines at odd-numbered positions]−[average of widths of dark lines at even-numbered positions]>([standard deviation of widths of dark lines at odd-numbered positions]+[standard deviation of widths of dark lines at even-numbered positions])/2.

[3] The liquid crystal diffraction element according to [1] or [2],
in which the liquid crystal alignment pattern is a concentric circular pattern that has the one direction in which the orientation of the optical axis derived from the liquid crystal compound changes while continuously rotating, in a concentric circular shape from an inner side toward an outer side.

According to the present invention, it is possible to provide a liquid crystal diffraction element which can convert a zeroth-order ray into polarized light different from an incidence ray.

### BRIEF DESCRIPTION OF THE DRAWINGS

FIG. 1 is a view conceptually showing an example of a liquid crystal diffraction element according to the embodiment of the present invention.

FIG. 2 is a view conceptually showing a plane of the liquid crystal diffraction element shown in FIG. 1.

FIG. 3 is a conceptual view showing an action of the liquid crystal diffraction element.

FIG. 4 is a conceptual view showing the action of the liquid crystal diffraction element.

FIG. 5 is a conceptual view showing the liquid crystal diffraction element according to the embodiment of the present invention.

FIG. 6 is a conceptual view showing the action of the liquid crystal diffraction element according to the embodiment of the present invention.

FIG. 7 is a view conceptually showing another example of the liquid crystal diffraction element according to the embodiment of the present invention.

FIG. 8 is a view conceptually showing another example of the liquid crystal diffraction element according to the embodiment of the present invention.

FIG. 9 is a conceptual view showing the liquid crystal diffraction element shown in FIG. 8.

FIG. 10 is a view conceptually showing another example of the liquid crystal diffraction element according to the embodiment of the present invention.

FIG. 11 is a view conceptually showing another example of the liquid crystal diffraction element according to the embodiment of the present invention.

FIG. 12 is a view conceptually showing an example of an exposure device which exposes an alignment film.

FIG. 13 is a view conceptually showing another example of the exposure device which exposes an alignment film.

FIG. 14 is a view conceptually showing a plane of a liquid crystal diffraction element in the related art.

### DESCRIPTION OF THE PREFERRED EMBODIMENTS

Hereinafter, the liquid crystal diffraction element according to the embodiment of the present invention will be described in detail based on suitable embodiments shown in the accompanying drawings.

In the present specification, a numerical range represented by “to” means a range including numerical values before and after “to” as a lower limit value and an upper limit value.

In the present specification, “(meth)acrylate” is used to mean “either or both of acrylate and methacrylate”.

In addition, all of the drawings shown below are conceptual views for describing the present invention, and the positional relationship, size, thickness, shape, and the like of each constituent are different from the actual ones.

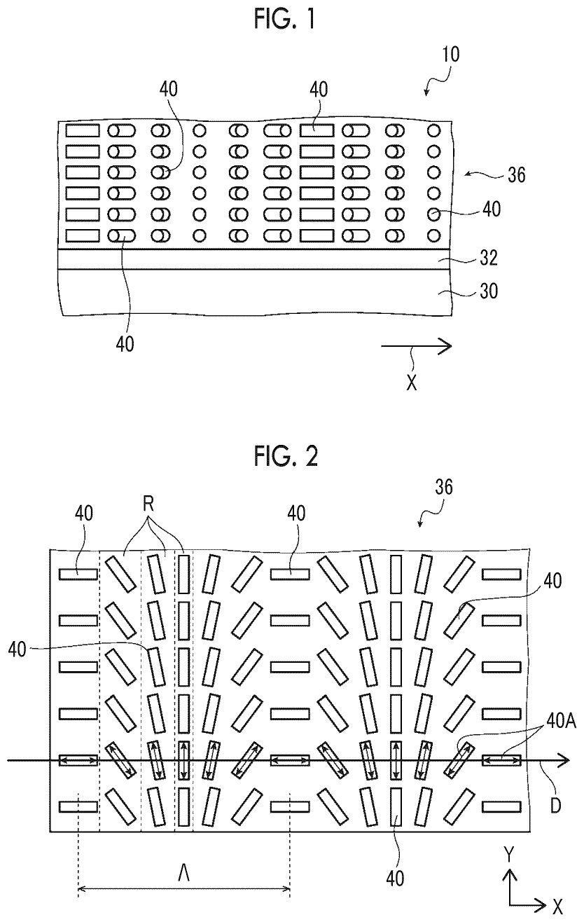

FIG. 1 conceptually shows an example of the liquid crystal diffraction element according to the embodiment of the present invention.

A liquid crystal diffraction element 10 shown in FIG. 1 includes a support 30, an alignment film 32, and an optically anisotropic layer 36.

FIG. 2 conceptually shows a plan view of the optically anisotropic layer 36.

The plan view is a view in a case where the liquid crystal diffraction element is seen from the top in FIG. 1, that is, a view in a case where the liquid crystal diffraction element is viewed from a thickness direction. The thickness direction is laminating direction of the respective layers (films). In other words, the plan view is a view in a case where the optically anisotropic layer 36 is viewed from a direction orthogonal to a main surface. The main surface is a maximum surface of a sheet-like material (a film, a layer, or a plate-like material), and is usually on both surfaces of the sheet-like material in a thickness direction.

In addition, in order to clarify the configuration of the liquid crystal diffraction element according to the embodiment of the present invention in FIG. 2, only a liquid crystal compound 40 on a surface of the alignment film 32 is shown with regard to the liquid crystal compound 40. However, in the thickness direction, as shown in FIG. 1, the optically anisotropic layer 36 has a structure in which the liquid crystal compound 40 is laminated on the liquid crystal compound 40 of the surface of the alignment film 32.

In FIG. 2, a part in a plane of the optically anisotropic layer 36 will be described as a representative example, but basically, the same configurations and effects are provided at each position in the plane of the optically anisotropic layer.

The optically anisotropic layer 36 has a liquid crystal alignment pattern in which an orientation of an optical axis 40A derived from the liquid crystal compound 40 changes while continuously rotating in an arrangement axis D direction in a plane of the optically anisotropic layer 36. The arrangement axis D direction coincides with an arrow X direction described later. In the example shown in the drawing, a rod-like liquid crystal compound is exemplified as the liquid crystal compound 40, and thus the optical axis coincides with a longitudinal direction of the rod-like liquid crystal compound.

In the following description, the “optical axis derived from the liquid crystal compound” will also be simply referred to as “optical axis of the liquid crystal compound”.

Specifically, the fact that the orientation of the optical axis 40A changes while continuously rotating in the arrangement axis D direction (one direction) means that an angle between the optical axis 40A of the liquid crystal compound 40, which is arranged in the arrangement axis D direction, and the arrangement axis D direction varies depending on positions in the arrangement axis D direction, and an angle between the optical axis 40A and the arrangement axis D direction sequentially changes from θ to θ+180° or θ−180° in the arrangement axis D direction.

Meanwhile, regarding the liquid crystal compound 40 forming the optically anisotropic layer 36, the liquid crystal compounds 40 in which the orientations of the optical axes 40A are the same as one another are arranged at equal intervals in the Y direction orthogonal to the arrangement axis D direction, that is, the Y direction orthogonal to one direction in which the optical axes 40A continuously rotate.

In other words, in the optically anisotropic layer 36, angles between the orientations of the optical axes 40A and the arrangement axis D direction are the same in the liquid crystal compounds 40 arranged in the Y direction.

In the liquid crystal diffraction element according to the embodiment of the present invention, in the liquid crystal alignment pattern of the liquid crystal compound 40, a length (distance) over which the orientation of the optical axis 40A rotates by 180° in one direction (in the example shown in the drawing, the arrangement axis D direction) in which the optical axis 40A changes while continuously rotating in the plane is a length Λ of the single period in the liquid crystal alignment pattern. In other words, the length of the single period in the liquid crystal alignment pattern is defined as a distance between θ and θ+180°, that is a range of the angle between the optical axis 40A of and the arrangement axis D direction. The length of the single period in the liquid crystal alignment pattern refers to the length of the single period in a periodic structure of the diffraction element.

That is, a distance between centers of two liquid crystal compounds 40 in the arrangement axis D direction is the length Λ of the single period, the two liquid crystal compounds having the same angle in the arrangement axis D direction. Specifically, as shown in FIG. 2, a distance between centers in the arrangement axis D direction of two liquid crystal compounds 40 in which the arrangement axis D direction and the direction of the optical axis 40A match each other is the length Λ of the single period. In the description below, the length Λ of the single period is also referred to as “single period A”.

In the liquid crystal diffraction element according to the embodiment of the present invention, in the liquid crystal alignment pattern of the optically anisotropic layer, the single period Λ is repeated in the arrangement axis D direction, that is, in the one direction in which the orientation of the optical axis 40A changes while continuously rotating.

As described above, in the optically anisotropic layer, the liquid crystal compounds arranged in the Y direction have the same angle between the optical axis 40A and the arrangement axis D direction as one direction in which the orientation of the optical axis of the liquid crystal compound 40 rotates. A region where the liquid crystal compounds 40 in which the angles between the optical axes 40A and the arrangement axis D direction are the same are arranged in the Y direction will be referred to as a region R.

In this case, it is preferable that an in-plane retardation (Re) value of each of the regions R is a half wavelength, that is, λ/2. The in-plane retardation is calculated from a product of a difference in refractive index Δn due to refractive index anisotropy of the region R and a thickness of the optically anisotropic layer. Here, a difference in refractive index due to the refractive index anisotropy of the regions R in the optically anisotropic layer is defined by a difference between a refractive index of a direction of an in-plane slow axis of the region R and a refractive index of a direction orthogonal to the direction of the slow axis. That is, the difference in refractive index Δn due to the refractive index anisotropy of the regions R is the same as a difference between a refractive index of the liquid crystal compound 40 in the direction of the optical axis 40A and a refractive index of the liquid crystal compound 40 in a direction perpendicular to the optical axis 40A in a plane of the region R. That is, the above-described difference in refractive index Δn is the same as the difference in refractive index of the liquid crystal compound.

In a case where circularly polarized light is incident into the optically anisotropic layer 36 (liquid crystal diffraction element), the light is diffracted (refracted), and a turning direction of the circularly polarized light is converted.

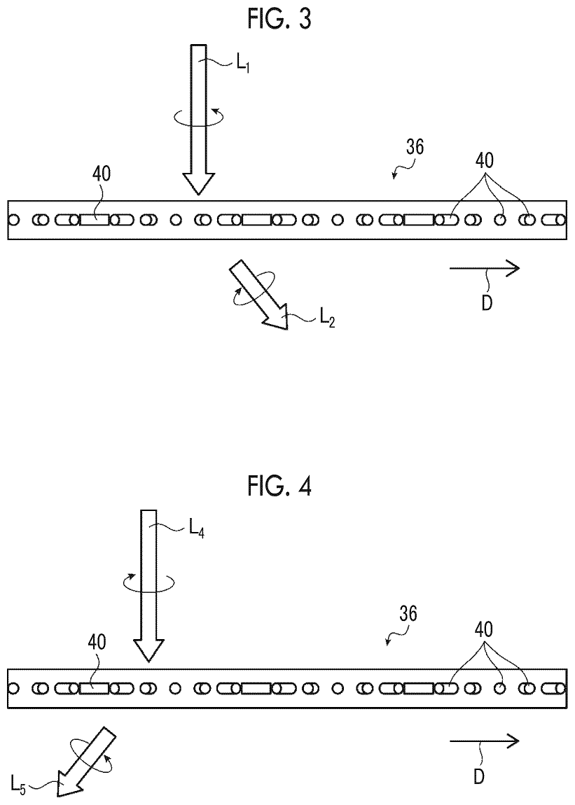

The action is conceptually shown in FIGS. 3 and 4. In order to simplify the drawing to clarify the configuration of the liquid crystal diffraction element in FIGS. 3 and 4, only the liquid crystal compound 40 (liquid crystal compound molecule) on the surface of the alignment film in the optically anisotropic layer 36 is shown.

In addition, in the optically anisotropic layer 36, a product of the difference in refractive index of the liquid crystal compound and the thickness of the optically anisotropic layer is set to λ/2.

As shown in FIG. 3, in a case where the value of the product of the difference in refractive index of the liquid crystal compound and the thickness of the optically anisotropic layer in the optically anisotropic layer 36 is λ/2 and an incidence ray L₁ as levorotatory circularly polarized light is incident into the optically anisotropic layer 36, the incidence ray L₁ is transmitted through the optically anisotropic layer 36 to be imparted with a retardation of 180°, and a transmitted ray L₂ is converted into dextrorotatory circularly polarized light.

In addition, the liquid crystal alignment pattern formed in the optically anisotropic layer 36 is a pattern which is periodic in the arrangement axis D direction, so that the transmitted ray L₂ travels in a direction different from a traveling direction of the incidence ray L₁. In this way, the incidence ray L₁ of the levorotatory circularly polarized light is converted into the transmitted ray L₂ of the dextrorotatory circularly polarized light, which is tilted by a predetermined angle in the arrangement axis D direction with respect to an incidence direction.

On the other hand, as shown in FIG. 4, in a case where the value of the product of the difference in refractive index of the liquid crystal compound of the optically anisotropic layer 36 and the thickness of the optically anisotropic layer 36 is λ/2 and an incidence ray L₄ as dextrorotatory circularly polarized light is incident into the optically anisotropic layer 36, the incidence ray L₄ is transmitted through the optically anisotropic layer 36 to be imparted with a retardation of 180° and is converted into a transmitted ray L₅ of a levorotatory circularly polarized light.

In addition, the liquid crystal alignment pattern formed in the optically anisotropic layer 36 is a pattern which is periodic in the arrangement axis D direction, so that the transmitted ray L₅ travels in a direction different from a traveling direction of the incidence ray L₄. In this case, the transmitted ray L₅ travels in a direction different from the transmitted ray L₂, that is, in a direction opposite to the arrangement axis D direction with respect to the incidence direction. In this way, the incidence ray L₄ is converted into the transmitted ray L₅ of the levorotatory circularly polarized light, which is tilted by a predetermined angle in a direction opposite to the arrangement axis D direction with respect to the incidence direction.

Here, in the liquid crystal diffraction element according to the embodiment of the present invention, the optically anisotropic layer 36 has the following characteristics.

First, in the liquid crystal alignment pattern, an average period in 50 periods from a single period having the longest length along the one direction in which the optical axis 40A continuously rotates, that is, along the arrangement axis D direction is calculated and is defined as an average period Λa. In the following description, the one direction in which the optical axis 40A continuously rotates will also be simply referred to as “one direction in which the optical axis 40A rotates”.

Next, a region having a single period equal to or less than the average period Λa is randomly selected, and the main surface of the optically anisotropic layer 36 (liquid crystal diffraction element 10) is observed under crossed nicols with an optical microscope in the region. Specifically, the liquid crystal diffraction element 10 is disposed between polarizers disposed in the crossed nicols, and the main surface of the optically anisotropic layer 36 is observed with an optical microscope in the optionally selected region as described above. In this case, the optically anisotropic layer 36 is disposed such that an absorption axis of one polarizer among the polarizers constituting the crossed nicols and the arrangement axis D direction, that is, the one direction in which the optical axis 40A rotates are parallel to each other, and the observation is performed with an optical microscope.

As described above, in the optically anisotropic layer 36, the optical axis 40A of the liquid crystal compound 40 continuously rotates in the arrangement axis D direction. In addition, in the Y direction orthogonal to the arrangement axis D direction (X direction), the directions of the optical axes of the liquid crystal compounds 40 are aligned.

Therefore, in a region where the optical axis 40A coincides with the absorption axis of the polarizer constituting the crossed nicols and a region where the angle formed with the absorption axis is small, light is shielded and a dark line extending in the Y direction is observed. On the other hand, in a region where the optical axis 40A is orthogonal to the absorption axis of the polarizer constituting the crossed nicols and a region having an angle close to orthogonality, light is transmitted and a bright line extending in the Y direction is observed.

In the following description, the “region where the optical axis 40A coincides with the absorption axis of the polarizer constituting the crossed nicols and region where the angle formed with the absorption axis is small” is also referred to as “region where the optical axis 40A (substantially) coincides with the absorption axis of the polarizer” for convenience.

In addition, the “region where the optical axis 40A is orthogonal to the absorption axis of the polarizer constituting the crossed nicols and region having an angle close to orthogonality” is also referred to as “region where the optical axis 40A is (substantially) orthogonal to the absorption axis of the polarizer” for convenience.

Next, by using the direction of the absorption axis of the polarizer parallel to the arrangement axis D direction as the observation direction, among bright lines and dark lines to be observed, a dark line having a width wider than the width of the dark line on both adjacent sides is optionally selected. That is, a dark line interposed between dark lines narrower than itself in the arrangement axis D direction is randomly selected.

Furthermore, 80 dark lines which are continuous in the observation direction, that is, in the arrangement axis D direction (one direction), that is, in the direction of the absorption axis of the polarizer are selected with the randomly selected dark line as a first dark line.

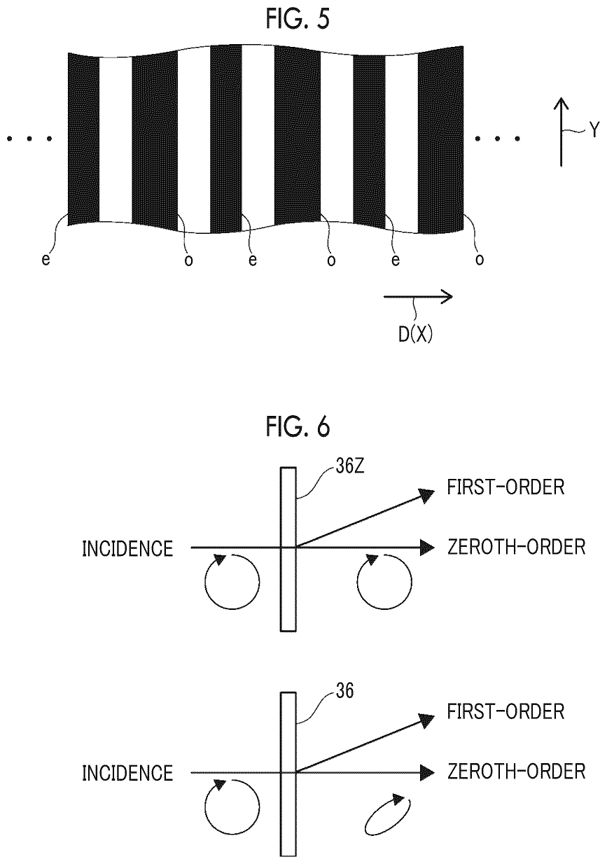

In the optically anisotropic layer of the liquid crystal diffraction element according to the embodiment of the present invention, in the 80 continuous dark lines selected as described above, as conceptually shown in FIG. 5, a width of a dark line e at an even-numbered position is narrower than a width of a dark line o at an odd-numbered position, which is adjacent to the dark line e; and a width of a dark line o at an odd-numbered position is wider than a width of a dark line e at an even-numbered position, which is adjacent to the dark line o.

That is, the optically anisotropic layer 36 constituting the liquid crystal diffraction element according to the embodiment of the present invention is observed by an optical microscope in the main surface with a crossed nicols in which the arrangement axis D direction, that is, the one direction in which the optical axis 40A rotates coincides with the direction of the absorption axis of one polarizer. In this case, in the optically anisotropic layer 36 constituting the liquid crystal diffraction element according to the embodiment of the present invention, as conceptually shown in FIG. 5, repetition of bright lines and dark lines extending in the Y direction orthogonal to the arrangement axis D direction is observed, and in the dark lines in the repetition, repetition of “thicker than the next line”→ “thinner than the next line”→ “thicker than the next line”→ “thinner than the next line” . . . is observed between the adjacent dark lines in the arrangement axis D direction.

Since the liquid crystal diffraction element according to the embodiment of the present invention includes the optically anisotropic layer 36, the liquid crystal diffraction element 10 (optically anisotropic layer 36) can convert the polarization of the zeroth-order ray transmitted through the optically anisotropic layer 36 without being diffracted into polarization different from that of the incidence ray.

In the optically anisotropic layer having the liquid crystal alignment pattern in which the optical axis of the liquid crystal compound continuously rotates in one direction, as the liquid crystal diffraction element in the related art disclosed in JP2012-505430A, the rotation of the optical axis 40A in the single period Λ in the arrangement axis D direction is constant as in the optically anisotropic layer 36Z conceptually shown in FIG. 14.

That is, in the optically anisotropic layer 36Z of the liquid crystal diffraction element in the related art, in the single period Λ that a state in which the optical axis 40A is parallel to the arrangement axis D changes to a state in which the optical axis 40A is orthogonal to the arrangement axis D and then changes to the state in which the optical axis 40A is parallel to the arrangement axis D, a rotation angle of the optical axis 40A is substantially constant. In other words, in the optically anisotropic layer 36Z of the liquid crystal diffraction element in the related art, the rotation of the optical axis 40A in the single period Λ is linear rotation in which the rotation angle is constant.

In the following description, the liquid crystal alignment pattern in which the rotation of the optical axis 40A in the single period Λ is constant as described above will also be referred to as “linear liquid crystal alignment pattern” for convenience.

As described above, in the region where the optical axis 40A substantially coincides with the absorption axis of the polarizer, light is shielded and a dark line extending in the Y direction is observed. Accordingly, in a case where the liquid crystal alignment pattern is linear, the thickness of the dark line arranged in the arrangement axis D direction is substantially constant.

In the liquid crystal diffraction element in the related art, including the optically anisotropic layer 36Z having the linear liquid crystal alignment pattern, it is known that a polarization state of a zeroth-order ray which travels linearly and is transmitted without being diffracted by the liquid crystal diffraction element (optically anisotropic layer) is the same as that of the incidence ray.

That is, as conceptually shown in an upper part of FIG. 6, in the optically anisotropic layer 36Z in the related art, having the linear liquid crystal alignment pattern, in a case where the incidence ray is a dextrorotatory circularly polarized light, the zeroth-order ray is also dextrorotatory circularly polarized light as it is.

On the other hand, in the optically anisotropic layer 36 in the liquid crystal diffraction element 10 according to the embodiment of the present invention, as conceptually shown in FIG. 2, the rotation of the optical axis 40A in the single period Λ is not constant.

In the optically anisotropic layer 36 in the example shown in the drawing, in the single period Λ, the optical axis 40A is rotated by a large rotation angle from a state of being parallel to the arrangement axis D to a state of being close to an angle orthogonal to the arrangement axis D, and then the optical axis 40A is rotated by a small rotation angle to be orthogonal to the arrangement axis D, and further, the optical axis 40A is rotated by a small rotation angle, the rotation angle increases, and the optical axis 40A is parallel to the arrangement axis D again. That is, in the optically anisotropic layer 36 in the liquid crystal diffraction element 10 according to the embodiment of the present invention, the rotation angle of the optical axis 40A in the single period Λ decreases from the large state and then increases again. In other words, in the optically anisotropic layer 36 of the liquid crystal diffraction element 10 according to the embodiment of the present invention, the rotation of the optical axis 40A in the single period Λ is a non-linear rotation in which the rotation angle changes.

In the following description, the liquid crystal alignment pattern in which the rotation of the optical axis 40A in the single period Λ is not constant as described above will also be referred to as “non-linear liquid crystal alignment pattern” for convenience.

As described above, in the region where the optical axis 40A substantially coincides with the absorption axis of the polarizer, light is shielded and a dark line extending in the Y direction is observed.

Here, in a case where the liquid crystal alignment pattern is non-linear, in the single period, the width of the region where the optical axis 40A and the absorption axis of the polarizer disposed in the crossed nicols (substantially) match each other changes in the arrangement axis D direction. In the optically anisotropic layer 36 shown in FIG. 2, the width of the region in the arrangement axis D direction, which (substantially) coincides with the absorption axis in the arrangement axis D direction, is narrow; and the width of the region in the arrangement axis D direction, which substantially coincides with the absorption axis in the Y direction orthogonal to the arrangement axis D direction, is wide.

As a result, in the optically anisotropic layer 36 having the non-linear liquid crystal alignment pattern, as shown in FIG. 5, a thick dark line and a thin dark line are alternately observed in the arrangement axis D direction.

In other words, in the optically anisotropic layer 36 in which the width of the dark line e at an even-numbered position is narrower than the width of the dark line o at an odd-numbered position, which is adjacent to the dark line e, and the width of the dark line o at an odd-numbered position is wider than the width of the dark line e at an even-numbered position, which is adjacent to the dark line o, in the 80 dark lines selected as described above, the rotation of the optical axis 40A in the single period is not constant and has the non-linear liquid crystal alignment pattern. That is, the optically anisotropic layer in which the thick dark line and the thin dark line are alternately observed in the arrangement axis D direction has the non-linear liquid crystal alignment pattern in which the rotation of the optical axis 40A in the arrangement axis D direction is not constant.

In the liquid crystal diffraction element according to the embodiment of the present invention, the optically anisotropic layer has the non-linear liquid crystal alignment pattern, and thus the polarization state of the zeroth-order ray of the optically anisotropic layer can be converted into a polarization state different from that of the incidence ray.

That is, as conceptually shown in a lower part of FIG. 6, in the optically anisotropic layer 36 having the non-linear liquid crystal alignment pattern used in the present invention, in a case where the incidence ray is dextrorotatory circularly polarized light, the zeroth-order ray can be converted into, for example, elliptically polarized light having a right turning direction.

By using the liquid crystal diffraction element according to the embodiment of the present invention, the zeroth-order ray can be converted into polarized light different from the incidence ray, and for example, in an application of image display in which the zeroth-order ray becomes stray light as described above, the zeroth-order ray can be removed.

In the liquid crystal diffraction element according to the embodiment of the present invention, it is preferable that the optically anisotropic layer 36 has a large difference between the width of the dark line having a wide width, that is, the width of the dark line o at an odd-numbered position, and the width of the dark line having a narrow width, that is, the width of the dark line e at an even-numbered position is large. As the difference is larger, the difference in polarization state between the incidence ray and the zeroth-order ray can be increased.

On the other hand, in the liquid crystal diffraction element according to the embodiment of the present invention, it is preferable that the optically anisotropic layer 36 has a small difference in thickness between the dark line having a wide width and the dark line having a narrow width. As the difference is smaller, it is preferable from the viewpoint that a plurality of diffracted light can be prevented from being generated at an unintended angle.

Specifically, in the liquid crystal diffraction element according to the embodiment of the present invention, it is preferable that the following expression is satisfied by the 80 continuous dark lines selected as described above in the optically anisotropic layer 36.

[Average of widths of dark lines at odd-numbered positions]−[Average of widths of dark lines at even-numbered positions]>([Standard deviation of widths of dark lines at odd-numbered positions]+[Standard deviation of widths of dark lines at even-numbered positions])/2

In a case where the optically anisotropic layer 36 satisfies the above expression, the above-described effect can be more suitably exhibited.

The change in zeroth-order ray with respect to the incidence ray is more satisfactorily exhibited as the diffraction efficiency of the liquid crystal diffraction element 10 (optically anisotropic layer 36) is higher. That is, as the diffraction efficiency of the liquid crystal diffraction element 10 increases, the change in zeroth-order ray with respect to the incidence ray increases.

Specifically, in the liquid crystal diffraction element 10 according to the embodiment of the present invention, in a case where levorotatory circularly polarized light and dextrorotatory circularly polarized light, having an absolute value of an ellipticity of 0.95 or more, are incident, a diffraction efficiency of at least one of first-order diffracted rays emitted from the liquid crystal diffraction element 10 is preferably 90% or more.

Since the liquid crystal diffraction element 10 according to the embodiment of the present invention satisfies the condition, and thus can greatly change the polarization state of zeroth-order ray with respect to the incidence ray.

By changing the single period Λ of the liquid crystal alignment pattern formed in the optically anisotropic layer 36, diffraction (refraction) angles of the transmitted rays L₂ and L₅ can be adjusted. Specifically, in the optically anisotropic layer 36, as the single period Λ of the liquid crystal alignment pattern decreases, light transmitted through the liquid crystal compounds 40 adjacent to each other more strongly interfere with each other. Therefore, the transmitted rays L₂ and L₅ can be more largely diffracted.

Accordingly, the optically anisotropic layer 36 has regions having different lengths of the single period Λ in the plane, and thus the optically anisotropic layer 36 can diffract incidence ray in different directions.

Furthermore, the optically anisotropic layer 36 may have a region where the length of the single period in the plane gradually changes in the one direction in which the liquid crystal compound rotates, that is, the arrangement axis D direction in the example shown in the drawing. By having such a region, a liquid crystal diffraction element which focuses or diffuses diffracted light (first-order light) can be obtained. For example, by gradually decreasing the single period Λ of the optically anisotropic layer in the arrangement axis D direction from the center of the arrangement axis D to both sides, a liquid crystal diffraction element which focuses diffracted light to the center in the arrangement axis D direction can be obtained.

In addition, by reversing the rotation direction of the optical axis 40A of the liquid crystal compound 40, which rotates in the arrangement axis D direction, the diffraction direction of the transmitted ray can be reversed. That is, in the example of FIGS. 3 and 4, the rotation direction of the optical axis 40A toward the arrangement axis D direction is clockwise, and by setting this rotation direction to be counterclockwise, the diffraction direction of the transmitted ray can be reversed.

Here, the diffraction angle (refraction angle) of the optically anisotropic layer 36 varies depending on the wavelength of incident light. Specifically, as the wavelength of light increases, the light is more largely diffracted. That is, in a case where the incident light is red light, green light, and blue light, the red light is diffracted to the highest degree, the green light is diffracted to the second highest degree, and the blue light is diffracted to the lowest degree.

As described above, the diffraction angle changes depending on the single period Λ in the liquid crystal alignment pattern of the optically anisotropic layer 36. As a result, by making the single period Λ in the liquid crystal alignment pattern of the optically anisotropic layer 36 constant, light having the same wavelength can be diffracted at the same angle.

In the optically anisotropic layer 36, it is preferable that the in-plane retardation value of the plurality of the regions R is a half wavelength, and it is preferable that an in-plane retardation Re(550)=Δn₅₅₀×d of the plurality of the regions R of the optically anisotropic layer 36 with respect to an incidence ray having a wavelength of 550 nm is in a range defined by the following expression (1). Here, Δn₅₅₀ is a difference in refractive index due to the refractive index anisotropy of the region R in a case where the wavelength of the incidence ray is 550 nm, and d represents a thickness of the optically anisotropic layer 36.

$$200 nm \leq Δ {n}_{550} \times d \leq 350 nm \qquad ( 1 )$$

That is, in a case where the “in-plane retardation Re(550)=Δn₅₅₀×d” of the plurality of the regions R of the optically anisotropic layer 36 satisfies the expression (1), a sufficient amount of circularly polarized light components of light which has been incident into the optically anisotropic layer 36 can be converted into circularly polarized light traveling in a direction tilted in a forward or backward direction with respect to the arrangement axis D direction. It is more preferable that the in-plane retardation Re(550)=Δn₅₅₀×d is 225 nm≤Δn₅₅₀×d≤340 nm, and it is still more preferable that the in-plane retardation Re(550)=Δn₅₅₀×d is 250 nm≤Δn₅₅₀×d≤330 nm.

The above expression (1) is a range with respect to the incidence ray having a wavelength of 550 nm, but an in-plane retardation Re(λ)=Δn_{λ}×d of the plurality of the regions R of the optically anisotropic layer with respect to an incidence ray having a wavelength of λ nm is preferably in a range defined by the following expression (1-2), and can be appropriately set.

$$0.7 \times ( λ / 2 ) nm \leq Δ {n}_{λ} \times d \leq 1.3 \times ( λ / 2 ) nm \qquad ( 1 - 2 )$$

In addition, a value of the in-plane retardation of the plurality of the regions R of the optically anisotropic layer 36 in a range outside the range of the above expression (1) can also be used. Specifically, by adopting Δn₅₅₀×d<200 nm or 350 nm<Δn₅₅₀×d, light can be classified into light which travels in the same direction as a traveling direction of the incidence ray and light which travels in a direction different from a traveling direction of the incidence ray. In a case where Δn₅₅₀×d approaches 0 nm or 550 nm, the light component traveling in the same direction as the traveling direction of the incidence ray increases, and the light component traveling in a direction different from the traveling direction of the incidence ray decreases.

Furthermore, it is preferable that an in-plane retardation Re(450)=Δn₄₅₀×d of each of the regions R of the optically anisotropic layer 36 with respect to an incidence ray having a wavelength of 450 nm and an in-plane retardation Re(550)=Δn₅₅₀×d of each of the regions R of the optically anisotropic layer 36 with respect to an incidence ray having a wavelength of 550 nm satisfy the following expression (2). Here, Δn₄₅₀ represents a difference in refractive index due to the refractive index anisotropy of the region R in a case where the wavelength of the incidence ray is 450 nm.

$$( Δ {n}_{450} \times d ) / ( Δ {n}_{550} \times d ) < 1. \qquad ( 2 )$$

The expression (2) represents that the liquid crystal compound 40 in the optically anisotropic layer 36 has reverse dispersibility. That is, by satisfying the expression (2), the optically anisotropic layer 36 can correspond to incidence light having a wide wavelength range.

In the optically anisotropic layer 36 of the liquid crystal diffraction element 10 shown in FIGS. 1 and 2, the optical axis 40A of the liquid crystal compound 40 continuously rotates in the one direction, that is, in the arrangement axis D direction.

However, the present invention is not limited thereto, and in the optically anisotropic layer of the liquid crystal diffraction element according to the embodiment of the present invention, various aspects such as two directions orthogonal to each other can be used as the direction in which the optical axis 40A continuously rotates.

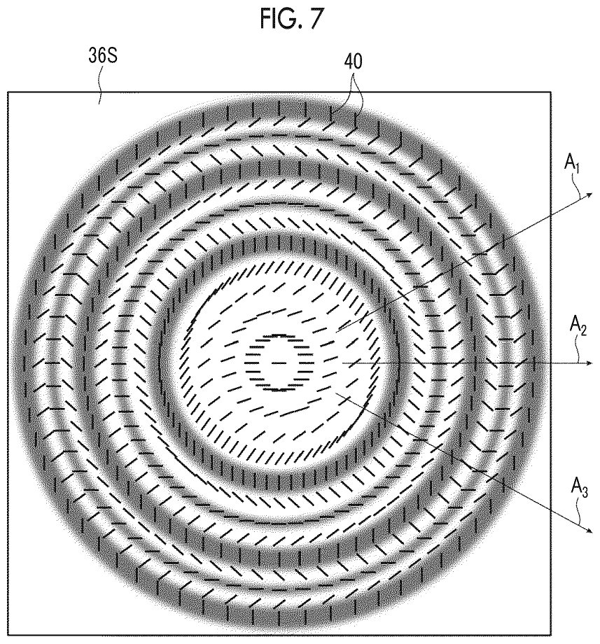

FIG. 7 conceptually shows an example thereof.

In an optically anisotropic layer 36S shown in FIG. 7, the liquid crystal alignment pattern has a concentric circular liquid crystal alignment pattern that one direction (arrows A₁ to A₃ and the like) in which the orientation of the optical axis of the liquid crystal compound 40 changes while continuously rotating is provided in a concentric circular shape from the inner side toward the outer side.

The concentric circular pattern is a pattern in which a line that connects liquid crystal compounds which have optical axes facing the same direction has a circular shape, and circular line segments have a concentric circular shape. In other words, the liquid crystal alignment pattern of the optically anisotropic layer 36S shown in FIG. 7 is a liquid crystal alignment pattern that has the one direction in which the orientation of the optical axis of the liquid crystal compound 40 changes while continuously rotating, in a radial shape from the center of the optically anisotropic layer 36S. That is, in the liquid crystal alignment pattern shown in FIG. 7, each direction from the center of the optically anisotropic layer 36S to the outer direction in a radial shape, such as the arrow A₁ direction, the arrow A₂ direction, and the arrow A₃ direction, corresponds to the arrangement axis D direction in the optically anisotropic layer 36 described above.

As described above, the optically anisotropic layer 36S shown in FIG. 7 has a concentric circular liquid crystal alignment pattern. Accordingly, in the present example, for example, in a case where the optically anisotropic layer 36S (liquid crystal diffraction element) is observed using an optical microscope under crossed nicols with the arrow A₂ direction in the drawing as an absorption axis in one polarizer, dark lines and bright lines are alternately observed in a concentric circular shape.

In addition, for 80 dark lines in the optically anisotropic layer 36S shown in FIG. 7, which are selected in the same manner as in the above-described example, a width of a dark line at an even-numbered position is narrower than a width of a dark line at an odd-numbered position, which is adjacent to the dark line at an even-numbered position; and a width of a dark line at an even-numbered position is wider than a width of a dark line at an odd-numbered position, which is adjacent to the dark line at an even-numbered position. Therefore, also in the present example, as conceptually shown in FIG. 7, dark lines having a width narrower than that of adjacent dark lines and dark lines having a width wider than that of adjacent dark lines are alternately observed in a concentric circular shape.

In FIG. 7, in order to clearly show the liquid crystal alignment pattern, the liquid crystal alignment pattern in the one direction is described as a linear liquid crystal alignment pattern.

However, in the optically anisotropic layer 36S in which dark lines having a width narrower than that of adjacent dark lines and dark lines having a width wider than that of adjacent dark lines are alternately observed in a concentric circular shape, the liquid crystal alignment pattern is non-linear as described above. Accordingly, even in the present example, the polarization state of the zeroth-order ray is converted into a state different from that of the incidence ray.

Even in the optically anisotropic layer 36S shown in FIG. 7, the optical axis (not shown) of the liquid crystal compound 40 is a longitudinal direction of the liquid crystal compound 40.

In the optically anisotropic layer 36S, the orientation of the optical axis of the liquid crystal compound 40 changes while continuously rotating in a direction in which a large number of optical axes move to the outer side from the center of the optically anisotropic layer 36, such as the direction indicated by the arrow A₁, the direction indicated by the arrow A₂, and the direction indicated by the arrow A₃. The arrow A₁, the arrow A₂, and the arrow A₃ are the same arrangement axes as the above-described arrangement axis D.

In addition, in the present example, the concentric circles having the optical axes of the liquid crystal compound 40 in the same direction correspond to the Y direction of the optically anisotropic layer 36 described above.

As a result, the optically anisotropic layer 36S shown in FIG. 7 also diffracts incidence ray in the arrow A₁, the arrow A₂, the arrow A₃, and the like. In addition, as in the above example, the zeroth-order ray is converted into polarized light different from the incidence ray.

In addition, the optically anisotropic layer 36S in the liquid crystal diffraction element has a region where the single period Λ of the liquid crystal alignment pattern differs in a plane.

Specifically, for example, with regard to the direction along the arrow A₁ in FIG. 7, in the direction in which the orientation of the optical axis of the liquid crystal compound 40 changes while continuously rotating, the single period Λ gradually decreases from the center toward the outer side. That is, in FIG. 7, the single period in the vicinity of the outer side is shorter than the single period in the vicinity of the center portion.

In the present invention, the fact that the single period Λ gradually changes means both of a case in which the single period Λ continuously changes and a case in which the single period Λ changes stepwise. Regarding this point, the same applies to the above-described example.

As described above, the diffraction angle of the liquid crystal diffraction element depends on the single period Λ of the liquid crystal alignment pattern, and the diffraction angle increases as the single period Λ decreases.

Accordingly, in the present example, the optically anisotropic layer 36S diffracts incidence ray toward the center. That is, the liquid crystal diffraction element including the optically anisotropic layer 36S can transmit incidence ray as focused light, and exhibits, for example, a function as a convex lens.

As described above, in the liquid crystal diffraction element according to the embodiment of the present invention, the optically anisotropic layer 36 is formed of a liquid crystal composition containing a liquid crystal compound, and has a liquid crystal alignment pattern in which the orientation of the optical axis of the liquid crystal compound changes while continuously rotating in at least one in-plane direction.

Here, in the optically anisotropic layer shown in FIG. 1, the liquid crystal compound 40 faces the same direction in a thickness direction.

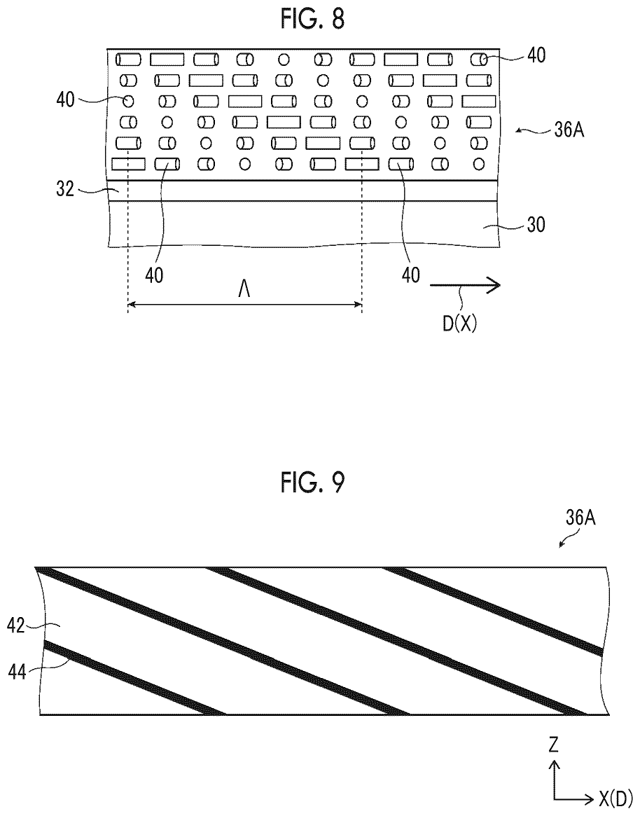

However, the present invention is not limited thereto, and the liquid crystal compound 40 may be helically twisted and aligned in the thickness direction as conceptually shown in the optically anisotropic layer 36A of FIG. 8.

In a cross-sectional image obtained by observing a cross section of the optically anisotropic layer having the above-described liquid crystal alignment pattern with a scanning electron microscope (SEM) in a thickness direction along a direction in which the optical axis continuously rotates, the optically anisotropic layer has the bright portions 42 and the dark portions 44, which extend from one surface to the other surface.

In the following description, an image obtained by observing a cross section of such an optically anisotropic layer with SEM will be also referred to as “cross-sectional SEM image” for convenience.

The bright portions 42 and the dark portions 44 in the cross-sectional SEM image are observed due to the liquid crystal phase having the liquid crystal alignment pattern.

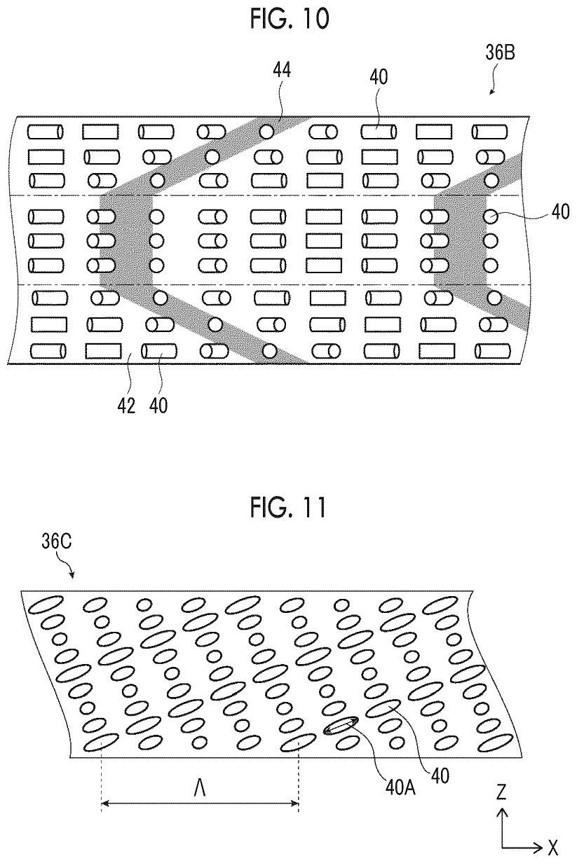

The optically anisotropic layer 36 in which the liquid crystal compound 40 is not helically twisted and aligned in the thickness direction shown in FIGS. 1 and 2 has bright portions 42 and dark portions 44, which extend from one surface to the other surface in the thickness direction, that is, orthogonal to the main surface in a cross-sectional SEM image (see FIG. 10).

On the other hand, as conceptually shown in FIG. 9, in the cross-sectional SEM image, the optically anisotropic layer 36A in which the liquid crystal compound 40 is helically twisted and aligned in the thickness direction has the bright portions 42 and the dark portions 44, which are tilted with respect to the thickness direction of the optically anisotropic layer 36A, that is, with respect to the main surface, and extend from one surface to the other surface.

As described above, in the optically anisotropic layer, by helically twisting and aligning the liquid crystal compound in the thickness direction, the diffraction efficiency can be increased, and the change in zeroth-order ray with respect to incidence ray can be further increased.

In the optically anisotropic layer 36A in which the liquid crystal compound 40 is helically twisted and aligned in the thickness direction as shown in FIG. 8, an angle of the dark portions 44 (the bright portions 42) with respect to the main surface in the cross-sectional SEM image can be adjusted by the length of the single period in the liquid crystal alignment pattern described above and a magnitude of the twist of the liquid crystal compound 40 which is twisted and aligned in the thickness direction.

Specifically, as the single period in the liquid crystal alignment pattern decreases, the angle of the dark portions 44 with respect to the main surface increases. In addition, as the twist in the thickness direction decreases, the angle of the dark portions 44 with respect to the main surface increases.

The helically twisted alignment of the liquid crystal compound in the optically anisotropic layer can be achieved by adding a chiral agent to the liquid crystal composition for forming the optically anisotropic layer, which will be described later. By selecting and adjusting the type and amount of the chiral agent, the twisted direction of the liquid crystal compound 40 and the degree of twisting of the liquid crystal compound 40 can be adjusted.

In the liquid crystal diffraction element according to the embodiment of the present invention, the optically anisotropic layer is not limited to the configuration in which the bright portions 42 and the dark portions 44 are linear as shown in FIG. 9.

As an example, as conceptually shown in an optically anisotropic layer 36B of FIG. 10, a configuration in which a region having the bright portions 42 and the dark portions 44, which extend in the thickness direction, is sandwiched between regions where tilted directions of the bright portions 42 and the dark portions 44 are opposite to each other, by sandwiching a region where the liquid crystal compound is not helically twisted and aligned between regions where helically twisted directions of the liquid crystal compound 40 in the thickness direction are opposite to each other, may be adopted.

In the X-Z plane of the optically anisotropic layer 36 of the examples shown in FIGS. 1 and 2, the optical axis 40A of the liquid crystal compound 40 is aligned in parallel with the main surface (X-Y plane).

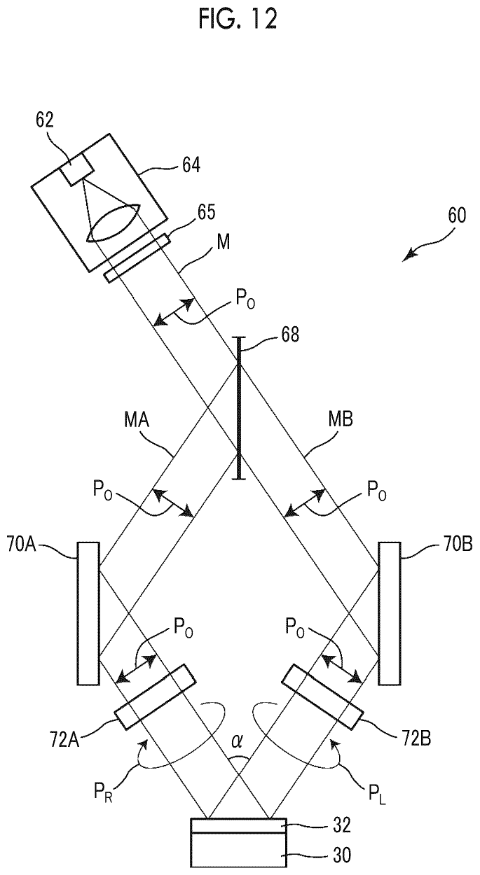

However, the present invention is not limited thereto. For example, as conceptually shown in FIG. 11, in the X-Z plane of an optically anisotropic layer 36C, the optical axis 40A of the liquid crystal compound 40 may be aligned to be tilted with respect to the main surface (X-Y plane).

In addition, in the X-Z plane of the optically anisotropic layer 36C of the example shown in FIG. 11, an inclined angle (tilt angle) of the optical axis 40A of the liquid crystal compound 40 with respect to the main surface (X-Y plane) is uniform in the thickness direction (Z direction), but the present invention is not limited to this. That is, the optically anisotropic layer 36C may have a region where the tilt angle of the optical axis 40A varies in the thickness direction.

For example, in the optically anisotropic layer 36C, the optical axis 40A is parallel to the main surface at the interface on the alignment film 32 side (tilt angle: 0°); the tilt angle of the optical axis 40A increases as the distance from the interface on the alignment film 32 side increases in the thickness direction; and the liquid crystal compound 40 may be aligned such that the tilt angle of the optical axis 40A is constant up to the other interface (air interface) side.

As described above, in the optically anisotropic layer, the optical axis 40A of the liquid crystal compound 40 may have a tilt angle on one interface of upper and lower interfaces, or the tilt angle may be provided on both interfaces. In addition, the tilt angles may be different at both interfaces.

As described above, in a case where the optical axis 40A of the liquid crystal compound 40 has a tilt angle (is inclined), the diffraction efficiency can be increased, and the change in zeroth-order ray with respect to incidence ray can be further increased.

The optically anisotropic layer of the liquid crystal diffraction element according to the embodiment of the present invention may have one or both of the configuration in which the optically anisotropic layer has the dark portions 44 inclined with respect to the main surface (thickness direction) in the cross-sectional SEM image and the configuration in which the optical axis 40A of the liquid crystal compound 40 is tilted.

Specifically, a configuration is preferable in which an average inclined angle of the dark portions 44 in the cross-sectional SEM image is 5° or more with respect to the main surface of the optically anisotropic layer, and a tilt angle of the optical axis 40A of the liquid crystal compound 40 is less than 5° in the thickness direction.

In addition, a configuration is also preferable in which the average inclined angle of the dark portions 44 in the cross-sectional SEM image is less than 5° with respect to the main surface of the optically anisotropic layer, and the tilt angle of the optical axis 40A of the liquid crystal compound 40 is 5° or more in the thickness direction.

Furthermore, a configuration is also preferable in which the average inclined angle of the dark portions 44 in the cross-sectional SEM image is 5° or more with respect to the main surface of the optically anisotropic layer, and the tilt angle of the optical axis 40A of the liquid crystal compound 40 is 5° or more in the thickness direction.

In the liquid crystal diffraction element according to the embodiment of the present invention, in a case where the optically anisotropic layer has the above-described configuration, the change in polarization state of the zeroth-order ray with respect to the incidence ray can be further increased. As a result, for example, a stray light suppression effect in a case where the zeroth-order ray becomes stray light and a light utilization rate improvement effect can be more suitably obtained.

As described above, the liquid crystal diffraction element 10 shown in FIGS. 1 and 2 includes the support 30, the alignment film 32, and the optically anisotropic layer 36.

The liquid crystal diffraction element according to the embodiment of the present invention is not limited to the example shown in FIG. 1, and various layer configurations can be adopted.

For example, the liquid crystal diffraction element according to the embodiment of the present invention may consist of the alignment film 32 and the optically anisotropic layer 36, by peeling off the support 30 from the liquid crystal diffraction element shown in FIG. 1. In addition, the liquid crystal diffraction element according to the embodiment of the present invention may consist of only the optically anisotropic layer 36, by peeling off the support 30 and the alignment film 32 from the liquid crystal diffraction element shown in FIG. 1. In addition, the liquid crystal diffraction element according to the embodiment of the present invention may consist of the support 30 and the optically anisotropic layer 36. Furthermore, in addition to the above-described configurations, the liquid crystal diffraction element according to the embodiment of the present invention may include other layers such as a protective layer (hard coat layer) and an antireflection layer.

That is, various layer configurations can be adopted as long as the liquid crystal diffraction element according to the embodiment of the present invention includes an optically anisotropic layer described later.

### <<Support>>

The support 30 supports the alignment film 32 and the optically anisotropic layer 36.

As the support 30, various sheet-shaped materials (films or plate-shaped materials) can be used as long as the support can support the alignment film and the optically anisotropic layer.

As the support 30, a transparent support is preferable, and examples thereof include a polyacrylic resin film such as polymethyl methacrylate, a cellulose-based resin film such as cellulose triacetate, a cycloolefin polymer-based film, polyethylene terephthalate (PET), polycarbonate, and polyvinyl chloride. The support is not limited to a flexible film and may be a non-flexible substrate such as a glass substrate. Examples of a commercially available product of the cycloolefin polymer-based film include “ARTON” (trade name) manufactured by JSR Corporation and “ZEONOR” (trade name) manufactured by Nippon Zeon Corporation.

In addition, the support 30 may have a multi-layer structure. Examples of the multi-layer support include a support including one of the above-described supports as a substrate and another layer provided on a surface of the substrate.

A thickness of the support 30 is not particularly limited and may be appropriately set depending on the use of the liquid crystal diffraction element, a material for forming the support 30, and the like in a range in which the alignment film and the optically-anisotropic layer can be supported.

The thickness of the support 30 is preferably 1 to 1,000 μm, more preferably 3 to 250 μm, and still more preferably 5 to 150 μm.

### <<Alignment Film>>

The alignment film 32 is formed on the surface of the support 30.

The alignment film 32 is an alignment film for aligning the liquid crystal compound 40 to the predetermined liquid crystal alignment pattern described above during the formation of the optically anisotropic layer 36.

As described above, in the liquid crystal diffraction element according to the embodiment of the present invention, the optically anisotropic layer has a liquid crystal alignment pattern in which the orientation of the optical axis 40A of the liquid crystal compound 40 (see FIG. 2) changes while continuously rotating in one in-plane direction (arrow X direction described later). Accordingly, the alignment film is formed such that the optically anisotropic layer can form the liquid crystal alignment pattern.

In addition, in the liquid crystal alignment pattern, a length over which the orientation of the optical axis 40A rotates by 180° in the one direction in which the orientation of the optical axis 40A changes while continuously rotating is set as a single period Λ (rotation period of the optical axis).

As the alignment film, various known films can be used.

Examples of the alignment film include a rubbed film formed of an organic compound such as a polymer, an obliquely deposited film formed of an inorganic compound, a film having a microgroove, and a film formed by lamination of Langmuir-Blodgett (LB) films formed with a Langmuir-Blodgett's method using an organic compound such as ω-tricosanoic acid, dioctadecylmethylammonium chloride, or methyl stearate.

The alignment film formed by a rubbing treatment can be formed by rubbing a surface of a polymer layer with paper or fabric in a given direction multiple times. Preferred examples of the material used for the alignment film include a material for forming polyimide, polyvinyl alcohol, a polymer having a polymerizable group described in JP1997-152509A (JP-H9-152509A), and an alignment film described in JP2005-97377A, JP2005-99228A, and JP2005-128503A.

In the liquid crystal diffraction element according to the embodiment of the present invention, for example, the alignment film can be suitably used as an alignment film obtained by irradiating a photo-alignment material with polarized light or non-polarized light, so-called photo-alignment film. That is, in the liquid crystal diffraction element according to the embodiment of the present invention, a photo-alignment film which is formed by applying a photo-alignment material onto the support 30 is suitably used as the alignment film.

The irradiation of polarized light can be performed in a direction perpendicular or oblique to the photo-alignment film, and the irradiation of non-polarized light can be performed in a direction oblique to the photo-alignment film.

Preferable examples of the photo-alignment material used in the photo-alignment film which can be used in the present invention include: an azo compound described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking ester described in JP2003-520878A, JP2004-529220A, and JP4162850B; and a photodimerizable compound, in particular, a cinnamate compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-12823A.

Among these, an azo compound, a photocrosslinking polyimide, a photocrosslinking polyamide, a photocrosslinking ester, a cinnamate compound, or a chalcone compound is suitability used.

The thickness of the alignment film is not particularly limited. The thickness with which a required alignment function can be obtained may be appropriately set depending on the material for forming the alignment film.

The thickness of the alignment film is preferably 0.01 to 5 μm and more preferably 0.05 to 2 μm.

A method for forming the alignment film is not limited, and various known methods can be used depending on the material for forming the alignment film. Examples thereof include a method including: applying the alignment film to a surface of the support 30; drying the applied alignment film; and exposing the alignment film to laser light to form an alignment pattern.

FIG. 12 conceptually shows an example of an exposure device which forms an alignment pattern corresponding to the liquid crystal alignment pattern in which the optical axis 40A of the liquid crystal compound 40 continuously rotates in the one direction shown in FIG. 2, that is, the arrangement axis D direction by exposing the alignment film.

An exposure device 60 shown in FIG. 12 includes a light source 64 including a laser 62, an λ/2 plate 65 which changes a polarization direction of a laser light M emitted from the laser 62, a beam splitter 68 which splits the laser light M emitted from the laser 62 into two beams MA and MB, mirrors 70A and 70B which are each disposed on an optical path of the splitted two beams MA and MB, and λ/4 plates 72A and 72B.

Although not shown in the drawing, the light source 64 emits linearly polarized light P₀. The λ/4 plate 72A converts the linearly polarized light P₀ (ray MA) into dextrorotatory circularly polarized light P_{R}, and the λ/4 plate 72B converts the linearly polarized light P₀ (ray MB) into levorotatory circularly polarized light P_{L}.

The support 30 including the alignment film 32 on which the alignment pattern is not yet formed is disposed at an exposed portion, the two rays MA and MB intersect and interfere each other on the alignment film 32, and the alignment film 32 is irradiated with and exposed to the interference light.

Due to the interference at this time, the polarization state of light with which the alignment film 32 is irradiated periodically changes according to interference fringes. As a result, in the alignment film 32, an alignment pattern in which the alignment state periodically changes can be obtained. That is, an alignment film having an alignment pattern in which the alignment state periodically changes can be obtained. In the following description, the alignment film having the alignment pattern will also be referred to as “patterned alignment film”.

In the exposure device 60, by changing an intersecting angle α between the two rays MA and MB, a period of the alignment pattern can be adjusted. That is, by adjusting the intersecting angle α in the exposure device 60, in the alignment pattern in which the optical axis 40A of the liquid crystal compound 40 continuously rotates in the one direction, the length of single period (single period A) over which the optical axis 40A rotates 180° in the one direction in which the optical axis 40A rotates can be adjusted.

By forming the optically anisotropic layer on the patterned alignment film having the alignment pattern in which the alignment state periodically changes, as described later, the optically anisotropic layer 36 having the liquid crystal alignment pattern in which the optical axis 40A of the liquid crystal compound 40 continuously rotates in the one direction can be formed.

In addition, by rotating the optical axes of the λ/4 plates 72A and 72B by 90°, respectively, the rotation direction of the optical axis 40A can be reversed.

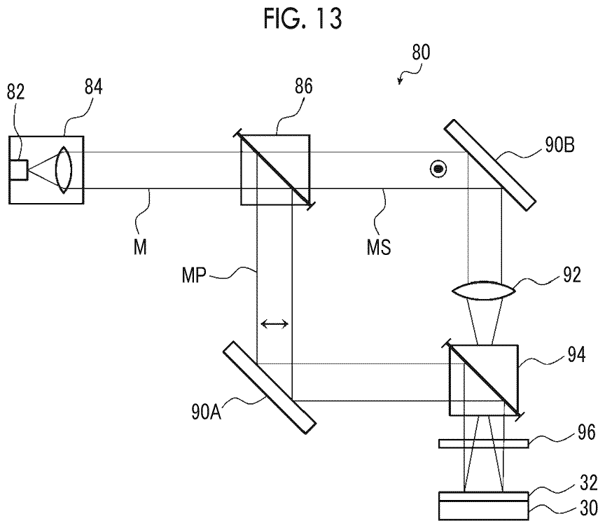

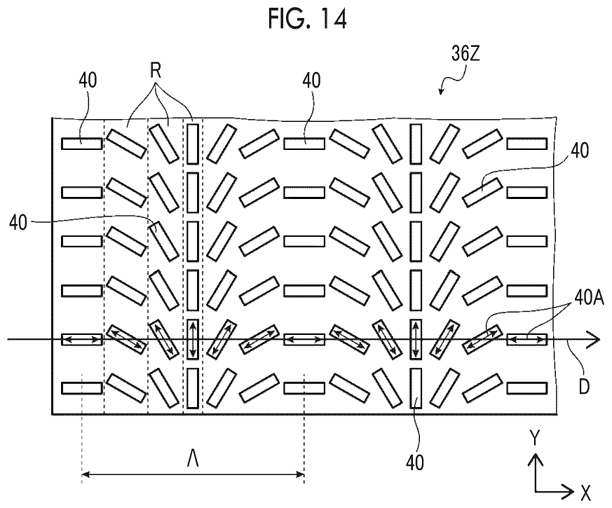

FIG. 13 conceptually shows an example of an exposure device which forms an alignment pattern corresponding to the concentric circular liquid crystal alignment pattern shown in FIG. 7.

An exposure device 80 shown in FIG. 13 includes a light source 84 which includes a laser 82, a polarization beam splitter 86 which splits a laser light M emitted from the laser 82 into an S-polarized light MS and a P-polarized light MP, a mirror 90A which is disposed on an optical path of the P-polarized light MP and a mirror 90B which is disposed on an optical path of the S-polarized light MS, a lens 92 which is disposed on the optical path of the S-polarized light MS, a polarization beam splitter 94, and a λ/4 plate 96.

The P-polarized light MP which is split by the polarization beam splitter 86 is reflected from the mirror 90A to be incident into the polarization beam splitter 94. On the other hand, the S-polarized light MS which is split by the polarization beam splitter 86 is reflected from the mirror 90B and is collected by the lens 92 to be incident into the polarization beam splitter 94.

The P polarized light MP and the S polarized light MS are combined by the polarization beam splitter 94, are converted into dextrorotatory circularly polarized light and levorotatory circularly polarized light by the λ/4 plate 96 depending on the polarization direction, and are incident into the alignment film 32 on the support 30.

Due to interference between the dextrorotatory circularly polarized light and the levorotatory circularly polarized light, the polarization state of light with which the alignment film is irradiated periodically changes according to interference fringes. An intersecting angle between dextrorotatory circularly polarized light and levorotatory circularly polarized light changes from the inside to the outside of the concentric circle, so that an exposure pattern in which the pitch changes from the inner side toward the outer side can be obtained. As a result, in the alignment film, a concentric circular alignment pattern in which the alignment state periodically changes can be obtained.

In the exposure device 80, the single period Λ of the liquid crystal alignment pattern in which the optical axis of the liquid crystal compound 40 continuously rotates by 180° in the one direction can be controlled by changing a focal power of the lens 92 (F number of the lens 92), the focal length of the lens 92, the distance between the lens 92 and the alignment film 32, and the like.

In addition, by adjusting the focal power of the lens 92, the length Λ of the single period of the liquid crystal alignment pattern in which the optical axis continuously rotates in the one direction can be changed.

Specifically, the length Λ of the single period in the liquid crystal alignment pattern in which the optical axis continuously rotates in the one direction can be changed depending on a light spread angle at which light is spread by the lens 92 due to interference with parallel light. More specifically, in a case where the focal power of the lens 92 is decreased, the light is close to the parallel light, so that the length Λ of the single period in the liquid crystal alignment pattern is gradually decreased from the inner side toward the outer side, and the F-number is increased. Conversely, in a case where the focal power of the lens 92 is stronger, the length A of the single period in the liquid crystal alignment pattern rapidly decreases from the inner side toward the outer side, and the F number is decreased.

As described above, the patterned alignment film has an alignment pattern which aligns the liquid crystal compound, such that the orientation of the optical axis of the liquid crystal compound 40 in the optically anisotropic layer formed on the patterned alignment film changes while continuously rotating over at least one in-plane direction to form a liquid crystal alignment pattern. Assuming that the axis along the orientation in which the liquid crystal compound 40 is aligned is an arrangement axis, it can be said that the patterned alignment film has an alignment pattern in which the orientation of the arrangement axis changes while continuously rotating over at least one in-plane direction. The arrangement axis of the patterned alignment film can be detected by measuring absorption anisotropy. For example, in a case where the patterned alignment film is irradiated with linearly polarized light while rotating the patterned alignment film and the amount of light transmitted through the patterned alignment film is measured, the orientation in which the amount of light is maximum or minimum is observed by gradually changing over one direction in the plane.

In the liquid crystal diffraction element according to the embodiment of the present invention, the alignment film is provided as a preferred aspect, and is not an essential configuration requirement.

For example, the following configuration can also be adopted, in which, by forming the alignment pattern on the support 30 using a method of rubbing the support 30, a method of processing the support 30 with laser light or the like, or the like, the optically anisotropic layer 36 and the like have the liquid crystal alignment pattern in which the orientation of the optical axis 40A derived from the liquid crystal compound 40 continuously changes in at least one in-plane direction.

Depending on the applications of the liquid crystal diffraction element, such as a case in which it is desired to provide a light amount distribution in transmitted light, a configuration in which regions having partially different lengths of the single periods A in the arrangement axis D direction are provided can also be used instead of the configuration in which the length of the single period Λ gradually changes in the arrangement axis D direction. For example, as a method of partially changing the single period Λ, a method of scanning and exposing the photo-alignment film to be patterned while freely changing a polarization direction of laser light to be collected can be used.

In addition, a wavelength of the laser light used for exposing the alignment film can be appropriately set depending on, for example, the kind of the alignment film to be used. For example, laser light having in a wavelength range of deep ultraviolet light to visible light to infrared light can be preferably used. For example, laser light having a wavelength of 266 nm, 325 nm, 355 nm, 370 nm, 385 nm, 405 nm, or 460 nm can be used. However, the laser is not limited to thereto, and laser light having various wavelengths can be used depending on the kind and the like of the alignment film.

The optically anisotropic layer may be peeled off and transferred from the alignment film after the optically anisotropic layer is provided on the alignment film. The transfer can also be performed multiple times according to a bonding surface of the optically anisotropic layer. The peeling and transfer method can be freely selected depending on the purposes. For example, by temporarily transferring the optically anisotropic layer to a substrate including an adhesive layer, transferring the laminate to an object to be transferred, and peeling off the substrate, the interface of the optically anisotropic layer on the alignment film side can be on the side of the object to be transferred. In addition, in order to set the surface of the optically anisotropic layer opposite to the alignment film side to face the object to be transferred, after bonding the optically anisotropic layer and the object to be transferred through an adhesive, the optically anisotropic layer may be peeled off from the alignment film.

In a case where the optically anisotropic layer is peeled off from the alignment film, in order to reduce damage (fracture, crack, and the like) to the optically anisotropic layer and the alignment film, it is preferable to adjust a peeling angle, a speed, or the like.

In addition, the alignment film may be repeatedly used in a range in which there is no problem in aligning properties. Before providing the optically anisotropic layer on the alignment film, the alignment film can be cleaned with an organic solvent or the like.

### <<Optically Anisotropic Layer>>

The optically anisotropic layer 36 is formed on the surface of the alignment film 32.

The optically anisotropic layer is formed by forming the alignment film 32 having the above-described alignment pattern on the support 30, applying a liquid crystal composition onto the alignment film, and curing the applied liquid crystal composition.

In addition, the structure in which the optical axis of the liquid crystal compound in the optically anisotropic layer is helically twisted and aligned in the thickness direction of the optically anisotropic layer, that is, the configuration in which the dark portions 44 is inclined with respect to the main surface (thickness direction) can be formed by adding a chiral agent to the liquid crystal composition, the chiral agent causing the liquid crystal compound to be helically aligned in the thickness direction.

As described above, the magnitude of the twisted alignment of the liquid crystal compound which is helically twisted and aligned in the thickness direction can be adjusted by the type of the chiral agent added to the liquid crystal composition and the addition amount of the chiral agent.

In addition, the twisted direction (right-twisted/left-twisted) of the liquid crystal compound in the thickness direction can also be selected by selecting the type of the chiral agent to be added to the liquid crystal composition.

The optically anisotropic layer functions as a so-called λ/2 plate, but in the present invention, an aspect in which a laminate integrally including the support and the alignment film functions as the λ/2 plate is included.

The liquid crystal composition for forming the optically anisotropic layer contains a rod-like liquid crystal compound or a disk-like liquid crystal compound, and may further contain other components such as a leveling agent, an alignment control agent, a polymerization initiator, and an alignment assistant.

In the present invention, a thickness of the optically anisotropic layer is not particularly limited and may be appropriately set depending on the single period Λ of the liquid crystal alignment pattern, the required diffraction angle, the diffraction efficiency, and the like, such that desired optical characteristics can be obtained.

### Rod-Like Liquid Crystal Compound

As the rod-like liquid crystal compound, azomethines, azoxys, cyano biphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolanes, and alkenylcyclohexylbenzonitriles are preferably used. In addition to the above-described low-molecular-weight liquid crystal molecules, a high-molecular-weight liquid crystal molecular can also be used.

It is preferable that the alignment of the rod-like liquid crystal compound is fixed by polymerization, and examples of the polymerizable rod-like liquid crystal compound include compounds described in Makromol. Chem., (1989), Vol. 190, p. 2255, Advanced Materials (1993), Vol. 5, p. 107, U.S. Pat. Nos. 4,683,327A, 5,622,648A, U.S. Pat. No. 5,770,107A, WO95/22586A, WO95/24455A, WO97/00600A, WO98/23580A, WO98/52905A, JP1989-272551A (JP-H1-272551A), JP1994-16616A (JP-H6-16616A), JP1995-110469A (JP-H7-110469A), JP1999-80081A (JP-H11-80081A), and JP2001-64627A. Furthermore, as the rod-like liquid crystal compound, for example, compounds described in JP1999-513019A (JP-H11-513019A) and JP2007-279688A can also be preferably used.

### Disk-Like Liquid Crystal Compound

As the disk-like liquid crystal compound, for example, compounds described in JP2007-108732A, JP2010-244038A, and the like can be preferably used.

In a case where a disk-like liquid crystal compound is used in the optically anisotropic layer, the liquid crystal compound 40 rises in the thickness direction in the optically anisotropic layer, and the optical axis 40A derived from the liquid crystal compound 40 is defined as an axis perpendicular to a disc plane, that is, a so-called fast axis.

In order to obtain a high diffraction efficiency, it is preferable that a liquid crystal compound having high difference in refractive index Δn is used as the liquid crystal compound. By increasing the refractive index anisotropy, a high diffraction efficiency can be maintained in a case where the incidence angle changes. The liquid crystal compound having high difference in refractive index Δn is not particularly limited, but compounds exemplified in WO2019/182129A and a compound represented by General Formula (I) can be preferably used.

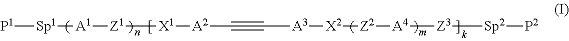

In General Formula (I), P¹ and P² each independently represent a hydrogen atom, —CN, —NCS, or a polymerizable group.

Sp¹ and Sp² each independently represent a single bond or a divalent linking group. However, Sp¹ and Sp² do not represent a divalent linking group including at least one group selected from the group consisting of an aromatic hydrocarbon ring group, an aromatic heterocyclic group, and an aliphatic hydrocarbon ring group.

Z¹, Z², and Z³ each independently represents a single bond, —O—, —S—, —CHR—, —CHRCHR—, —OCHR—, —CHRO—, —SO—, —SO₂—, —COO—, —OCO—, —CO—S—, —S—CO—, —O—CO—O—, —CO—NR—, —NR—CO—, —SCHR—, —CHRS—, —SO—CHR—, —CHR—SO—, —SO₂—CHR—, —CHR—SO₂—, —CF₂O—, —OCF₂—, —CF₂S—, —SCF₂—, —OCHRCHRO—, —SCHRCHRS—, —SO—CHRCHR—SO—, —SO₂—CHRCHR—SO₂—, —CH═CH—COO—, —CH═CH—OCO—, —COO—CH═CH—, —OCO—CH═CH—, —COO—CHRCHR—, —OCO—CHRCHR—, —CHRCHR—COO—, —CHRCHR—OCO—, —COO—CHR—, —OCO—CHR—, —CHR—COO—, —CHR—OCO—, —CR═CR—, —CR═N—, —N═CR—, —N═N—, —CR═N—N═CR—, —CF═CF—, or —C═C—. R represents a hydrogen atom or an alkyl group having 1 to 10 carbon atoms. In a case where a plurality of R's are present, R's may be the same or different from each other. In a case where a plurality of Z¹'s or a plurality of Z²'s are present, Z¹'s or Z²'s may be the same or different from each other. A plurality of Z³'s may be the same or different from each other. However, Z³ linked to SP² represents a single bond.

X¹ and X² each independently represents a single bond or —S—. A plurality of X¹'s or a plurality of X²'s may be the same or different from each other. However, at least one of the plurality of X¹'s or the plurality of X²'s represents —S—.

k represents an integer of 2 to 4.

m and n each independently represent an integer of 0 to 3. A plurality of m's may be the same or different from each other.

A¹, A², A³, and A⁴ each independently represent a group represented by any one of General Formulae (B-1) to (B-7) or a group in which two or three groups among the groups represented by General Formulae (B-1) to (B-7) are linked. A plurality of A²'s or a plurality of A³'s may be the same or different from each other. A plurality of A¹'s or a plurality of A⁴'s may be the same or different from each other.

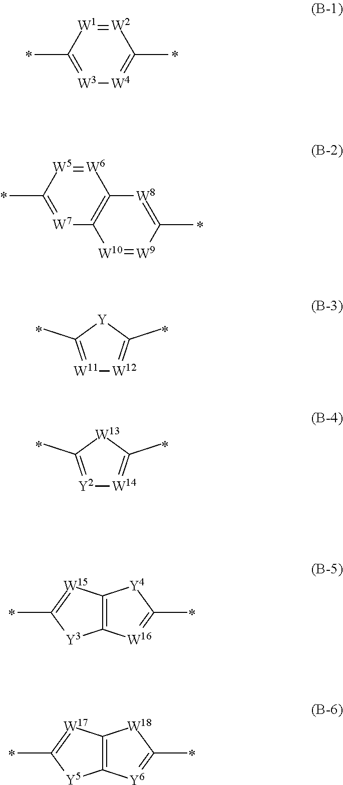

In General Formulae (B-1) to (B-7), W¹ to W¹⁸ each independently represent CR¹ or N, where R¹ represents a hydrogen atom or the following substituent L.

Y¹ to Y⁶ each independently represent NR², O, or S, where R² represents a hydrogen atom or the following substituent L.

G¹ to G⁴ each independently represent CR³R⁴, NR⁵, O, or S, where R³ to R⁵ each independently represent a hydrogen atom or the following substituent L.

M¹ and M² each independently represent CR⁶ or N, where R⁶ represents a hydrogen atom or the following substituent L.

* represents a bonding position.

The substituent L represents an alkyl group having 1 to 10 carbon atoms, an alkoxy group having 1 to 10 carbon atoms, an alkylamino group having 1 to 10 carbon atoms, an alkylthio group having 1 to 10 carbon atoms, an alkanoyl group having 1 to 10 carbon atoms, an alkanoyloxy group having 1 to 10 carbon atoms, an alkanoylamino group having 1 to 10 carbon atoms, an alkanoylthio group having 1 to 10 carbon atoms, an alkyloxycarbonyl group having 2 to 10 carbon atoms, an alkylaminocarbonyl group having 2 to 10 carbon atoms, an alkylthiocarbonyl group having 2 to 10 carbon atoms, a hydroxy group, an amino group, a mercapto group, a carboxy group, a sulfo group, an amide group, a cyano group, a nitro group, a halogen atom, or a polymerizable group. Here, in a case where the group described as the substituent L has —CH₂—, a group in which at least one —CH₂-in the group is substituted with —O—, —CO—, —CH═CH—, or —C≡C— is also included in the substituent L. In addition, in a case where the group described as the substituent L has a hydrogen atom, a group in which at least one hydrogen atom in the group is substituted with at least one selected from the group consisting of a fluorine atom and a polymerizable group is also included in the substituent L.

In order to maintain a high diffraction efficiency in a case where the incidence angle changes, a difference in refractive index Δn₅₅₀ of the liquid crystal compound is preferably 0.15 or more, more preferably 0.2 or more, still more preferably 0.25 or more, and most preferably 0.3 or more.

In addition, in the liquid crystal diffraction element according to the embodiment of the present invention, the difference in refractive index Δn or an average refractive index of the optically anisotropic layer may change in a plane. By changing the difference in refractive index Δn or the average refractive index of the optically anisotropic layer in the plane, the diffraction efficiency can be appropriately adjusted with respect to rays incident from different incidence positions.

### Chiral Agent

The chiral agent has a function of inducing a helical structure in which the liquid crystal compound is twisted and aligned in the thickness direction. The chiral agent may be selected depending on the purposes because a helical twisted direction and/or the degree of twist (helical pitch) derived from the compound varies.

The chiral agent is not particularly limited, and a known compound (for example, chiral agent for Twisted Nematic (TN) and Super Twisted Nematic (STN), described in “Liquid Crystal Device Handbook”, Chapter 3, Section 4-3, p. 199, Japan Society for the Promotion of Science edited by the 142nd committee, 1989), isosorbide (chiral agent having an isosorbide structure, an isomannide derivative, or the like can be used.

In addition, a chiral agent in which back isomerization, dimerization, isomerization, dimerization or the like occurs due to light irradiation so that the helical twisting power (HTP) decreases can also be suitably used.

The chiral agent generally includes an asymmetric carbon atom, but an axially asymmetric compound or a surface asymmetric compound, which does not have the asymmetric carbon atom, can also be used as the chiral agent. Examples of the axially asymmetric compound or the planar asymmetric compound include binaphthyl, helicene, paracyclophane, and derivatives thereof. The chiral agent may have a polymerizable group. In a case where both the chiral agent and the liquid crystal compound have a polymerizable group, a polymer having a repeating unit induced from the polymerizable liquid crystal compound and a repeating unit induced from the chiral agent can be formed by a polymerization reaction between the polymerizable chiral agent and the polymerizable liquid crystal compound. In this aspect, the polymerizable group of the polymerizable chiral agent is preferably the same polymerizable group as the polymerizable group of the polymerizable liquid crystal compound. Accordingly, the polymerizable group of the chiral agent is preferably an unsaturated polymerizable group, an epoxy group, or an aziridinyl group, more preferably an unsaturated polymerizable group, and still more preferably an ethylenically unsaturated polymerizable group.

In addition, the chiral agent may be a liquid crystal compound.

In a case where the chiral agent has a photoisomerization group, a pattern having a desired reflection wavelength corresponding to a luminescence wavelength can be formed by irradiation with actinic ray or the like through a photo mask after coating and alignment, which is preferable. As the photoisomerization group, an isomerization site of a compound exhibiting photochromic properties, an azo group, an azoxy group, or a cinnamoyl group is preferable. Specific examples of the compound include compounds described in JP2002-080478A, JP2002-080851A, JP2002-179668A, JP2002-179669A, JP2002-179670A, JP2002-179681A, JP2002-179682A, JP2002-338575A, JP2002-338668A, JP2003-313189A, JP2003-313292A, and the like.

A content of the chiral agent in the liquid crystal composition may be appropriately set depending on the desired amount of helical twist in the thickness direction, the type of the chiral agent, and the like.

As described above, in the optically anisotropic layer of the liquid crystal diffraction element according to the embodiment of the present invention, in the 80 continuous dark lines selected as described above, as conceptually shown in FIG. 5, the width of the dark line e at an even-numbered position is narrower than the width of the dark line o at an odd-numbered position, which is adjacent to the dark line e; and the width of the dark line o at an odd-numbered position is wider than the width of the dark line e at an even-numbered position, which is adjacent to the dark line o.

That is, as described above, in the liquid crystal diffraction element according to the embodiment of the present invention, the optically anisotropic layer has a non-linear liquid crystal alignment pattern in which the rotation of the optical axis of the liquid crystal compound in the single period is not constant.

Such a non-linear liquid crystal alignment pattern can be formed by appropriately performing selection of the liquid crystal compound, mixing of the liquid crystal compounds, selection and adjustment of the amount of the chiral agent to be added, mixing of a leveling agent, and the like in the liquid crystal composition for forming the optically anisotropic layer.

The non-linear liquid crystal alignment pattern can be formed by applying the liquid crystal composition obtained by adjusting these factors onto an alignment film having an alignment pattern corresponding to a typical linear liquid crystal alignment pattern, drying the liquid crystal composition, and optionally polymerizing the liquid crystal compound. In addition, after the application of the liquid crystal composition, a heating treatment may be performed as necessary in order to helically align the liquid crystal compound in the thickness direction.

Specifically, regarding the liquid crystal compound, nonlinearity of the liquid crystal alignment pattern can be changed depending on an elastic constant of the liquid crystal compound.

More specifically, the non-linearity of the liquid crystal alignment pattern can be changed by the balance of an elastic constant K11 for splay deformation, an elastic constant K22 for twist deformation, and an elastic constant K33 for bend deformation. For example, the non-linear liquid crystal alignment pattern can be formed depending on a case in which a value of K11/K33 or K33/K11 is large, a case in which a value of K22/K11 and/or K22/K33 is small, or the like.

In addition, regarding the chiral agent, the chiral agent is added to the liquid crystal composition for forming the optically anisotropic layer, so that the liquid crystal compound can be twisted and aligned in the thickness direction.

By twisting and aligning the liquid crystal compound in the thickness direction, the nonlinearity of the liquid crystal alignment pattern can be changed by combining with the liquid crystal compound having a large value of K11/K33 or K33/K11 described above or the liquid crystal compound having a small value of K22/K11 and/or K22/K33 described above, and thus the non-linear liquid crystal alignment pattern can be formed.

Regarding the leveling agent, the liquid crystal compound can be inclined (tilted) and aligned with respect to the main surface of the optically anisotropic layer depending on the type and amount of the leveling agent to be added.

By tilt-aligning the liquid crystal compound, the nonlinearity of the liquid crystal alignment pattern can be changed by combining with the liquid crystal compound having a large value of K11/K33 or K33/K11 described above or the liquid crystal compound having a small value of K22/K11 and/or K22/K33 described above, and thus the non-linear liquid crystal alignment pattern can be formed.

The selection and adjustment of the liquid crystal compound, chiral agent, and leveling agent may be performed only one time, or all of the selection and adjustment of the liquid crystal compound, chiral agents, and leveling agent may be performed.

The liquid crystal diffraction element according to the embodiment of the present invention is suitably used as an optical element, an optical unit, an optical module, an optical device, or the like in combination with various members.

For example, in the liquid crystal diffraction element according to the embodiment of the present invention, at least a part in a surface may be a curved surface.

By providing the curved surface portion in the liquid crystal diffraction element, for example, in a case where the liquid crystal diffraction element is used for a VR image display device such as a head-mounted display and AR glasses, it is possible to expand the viewing angle. In addition, by providing the curved surface portion in the liquid crystal diffraction element, chromatic aberration can be made less likely to occur.

Here, in the liquid crystal diffraction element according to the embodiment of the present invention, a method of forming the curved surface portion is not limited; and various known methods of forming at least a part of a sheet-like material into a curved shape can be used, but the following method is preferably exemplified.

That is, a base material having a main surface A and a main surface B, at least one of which is a curved surface, is prepared. The liquid crystal diffraction element according to the embodiment of the present invention is bonded to the main surface having a curved surface among the main surface A and the main surface B. As a result, an optical unit consisting of the base material and the liquid crystal diffraction element according to the embodiment of the present invention, in which the liquid crystal diffraction element has a curved shape along the curved surface of the base material, is obtained.

The base material is not limited, and a base material consisting of various known materials such as various resin materials, which transmit light diffracted by the liquid crystal diffraction element, can be used. In addition, the base material may have a curved surface on one main surface and a flat surface on the other main surface, or both main surfaces may have a curved surface.

The base material and the liquid crystal diffraction element may be bonded to each other by a known method using an optical clear adhesive (OCA) or the like. The liquid crystal diffraction element may be bonded to one main surface of the main surface A or the main surface B, or may be bonded to both main surfaces.

In addition, in the liquid crystal diffraction element according to the embodiment of the present invention, an alignment state of the optically anisotropic layer may be changed as an optical unit combined with an external input unit, without immobilizing the liquid crystal compound of the optically anisotropic layer.

For example, by changing the single period of the optically anisotropic layer using the external input unit, a variable focus lens can be realized with the above-described liquid crystal diffraction element having the concentric circular liquid crystal alignment pattern, which acts as a lens.

As the external input unit, various known units capable of changing the alignment state of the liquid crystal compound in various optical devices including a liquid crystal layer can be used. For example, an external input unit including a pair of substrates which sandwich the liquid crystal diffraction element and a transparent electrode provided on at least one of the substrates is exemplified.

In addition, the optical unit including the liquid crystal diffraction element according to the embodiment of the present invention and the external input unit may be an optical unit further combined with a liquid crystal cell. In the optical unit, a driving unit of the liquid crystal cell may be shared with the external input unit which changes the alignment state of the liquid crystal diffraction element according to the embodiment of the present invention, or a driving unit of the liquid crystal cell or the like may be separately provided.

Furthermore, the liquid crystal diffraction element according to the embodiment of the present invention is also suitable for being used as an optical unit in combination with a circularly polarizing plate.

By combining the liquid crystal diffraction element according to the embodiment of the present invention with the circularly polarizing plate, it is possible to allow desired circularly polarized light to be incident into the liquid crystal diffraction element according to the embodiment of the present invention. In addition, by combining the liquid crystal diffraction element according to the embodiment of the present invention with the circularly polarizing plate, it is also possible to emit the circularly polarized light diffracted by the liquid crystal diffraction element according to the embodiment of the present invention as linearly polarized light.

The circularly polarizing plate is not limited, and various known circularly polarizing plates such as a circularly polarizing plate in which a wave plate (retardation plate) such as a ¼ wavelength plate (λ/4 plate) and a linear polarizer are combined can be used.

That is, the liquid crystal diffraction element according to the embodiment of the present invention can be used as an optical unit in combination with various members.

In addition, the liquid crystal diffraction element according to the embodiment of the present invention and the optical unit including the liquid crystal diffraction element according to the embodiment of the present invention can be used as an optical module in combination with various members.

Furthermore, the liquid crystal diffraction element according to the embodiment of the present invention, the optical unit including the liquid crystal diffraction element according to the embodiment of the present invention, and the optical module including the liquid crystal diffraction element according to the embodiment of the present invention can be used in various optical devices.

Examples of the optical device including the liquid crystal diffraction element according to the embodiment of the present invention include a head-mounted display, a VR display device, a sensor, and a communication device.

Hereinbefore, the liquid crystal diffraction element according to the embodiment of the present invention has been described in detail, but the present invention is not limited to the above-described examples and various improvements and changes can be made without departing from the spirit of the present invention.

### EXAMPLES

Hereinafter, the characteristics of the present invention will be described in detail by Examples. Materials, chemicals, used amounts, material amounts, ratios, treatment details, treatment procedures, and the like shown in the following examples can be appropriately changed within a range not departing from the scope of the present invention. Therefore, the scope of the present invention should not be construed as being limited to the following specific examples.

### Comparative Example 1

A commercially available liquid crystal lens (manufactured by Edmund Optics Inc., Polarization Directed Flat Lens, #14-778) was prepared.

It was confirmed using a polarization microscope that an optically anisotropic layer of the liquid crystal lens had the concentric circular pattern as shown in FIG. 7. In the liquid crystal alignment pattern, regarding a single period over which the optical axis of the liquid crystal compound rotated by 180°, a single period of a portion at a distance of approximately 5 mm from the center was 4.0 μm; a single period of a portion at a distance of 10 mm from the center was 2.0 μm; and the single period decreased toward the outer direction.

An average period in 50 periods from the longest single period in one direction in which the optical axis of the liquid crystal compound rotated was 25 μm.

A main surface of the liquid crystal lens in a region having a single period equal to or less than the average period was observed with an optical microscope under crossed nicols. The observation was performed such that an absorption axis of one polarizer was parallel to one direction in which an optical axis derived from a liquid crystal compound in the liquid crystal lens rotated.

Using the direction of the absorption axis of the polarizer parallel to the one direction as the observation direction, among bright lines and dark lines to be observed, a dark line having a width wider than a width of dark lines on both adjacent sides was selected. However, in the liquid crystal lens, the widths of the dark lines were almost uniform, and no dark lines having a width wider than the width of the dark lines on both adjacent sides were found.

That is, it was confirmed that the optically anisotropic layer of the liquid crystal lens had a linear liquid crystal alignment pattern.

### Comparative Example 2

### <Production of Liquid Crystal Diffraction Element>

### (Support)

A glass substrate was used as a support.

### (Formation of Alignment Film)

The following coating liquid for forming an alignment film was applied onto the support by spin coating. The support on which the coating film of the alignment film-forming coating liquid was formed was dried using a hot plate at 60° C. for 60 seconds. As a result, an alignment film was formed.

### Alignment Film-Forming Coating Liquid

| | |
|---|---|
| Material A for photo-alignment | 1.00 part by mass |
| Water | 16.00 parts by mass |
| Butoxyethanol | 42.00 parts by mass |
| Propylene glycol monomethyl ether | 42.00 parts by mass |

-Material A for photo-alignment-

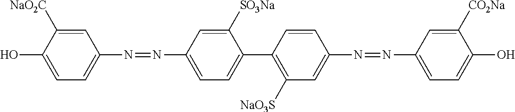

### (Exposure of Alignment Film)

The alignment film was exposed using the exposure device shown in FIG. 13 to form an alignment film P-1 having an alignment pattern.

In the exposure device, a laser which emitted laser light having a wavelength (355 nm) was used as the laser. An exposure amount of the interference light was set to 1,000 mJ/cm².

### (Formation of Optically Anisotropic Layer)

### <Formation of First Region>

As a liquid crystal composition for forming a first region of the optically anisotropic layer, the following composition A-1 was prepared.

### Composition A-1

| | |
|---|---|
| Liquid crystal compound L-1 | 100.00 parts by mass |
| Chiral agent C-1 | 0.33 parts by mass |
| Polymerization initiator (manufactured by BASF, Irgacure OXE 01) | 1.00 part by mass |
| Leveling agent T-1 | 0.08 parts by mass |
| Methyl ethyl ketone | 1050.00 parts by mass |

Liquid crystal compound L-1 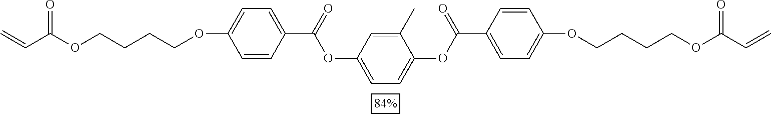 [SMILES: C=CC(=O)OCCCCOc1ccc(C(=O)Oc2ccc(OC(=O)c3ccc(OCCCCOC(=O)C=C)cc3)c(C)c2)cc1] 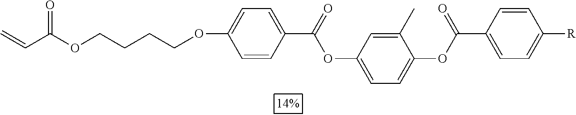 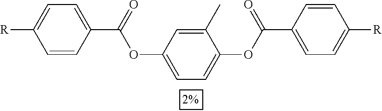 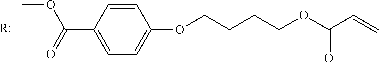
Chiral agent C-1 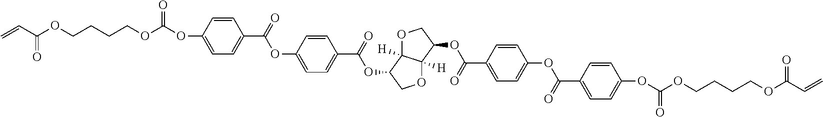 [SMILES: C=CC(=O)OCCCCOC(=O)Oc1ccc(C(=O)Oc2ccc(C(=O)O[C@H]3CO[C@H]4[C@@H]3OC[C@H]4OC(=O)c3ccc(OC(=O)c4ccc(OC(=O)OCCCCOC(=O)C=C)cc4)cc3)cc2)cc1]
Leveling agent T-1

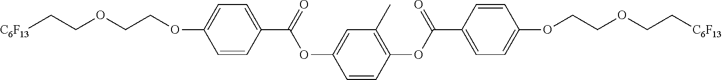

The composition A-1 was applied onto the alignment film P-1 in multiple layers to form a first region of the optically anisotropic layer. The application in multiple layers refers to repetition of processes including producing a first liquid crystal immobilized layer by applying the first layer-forming composition A-1 onto the alignment film, heating the composition A-1, and irradiating the composition A-1 with ultraviolet light for curing; and producing a second or subsequent liquid crystal immobilized layer by applying the second or subsequent layer-forming composition A-1 onto the formed liquid crystal immobilized layer, heating the composition A-1, and irradiating the composition A-1 with ultraviolet light for curing as described above.

Regarding the first liquid crystal layer, the following composition A-1 was applied onto the alignment film P-1 to form a coating film, the coating film was heated to 80° C. on a hot plate, the coating film was irradiated with ultraviolet rays having a wavelength of 365 nm at an irradiation amount of 300 mJ/cm² using a high-pressure mercury lamp in a nitrogen atmosphere, thereby fixing the alignment of the liquid crystal compound.

Regarding the second or subsequent layer, the composition was applied onto the liquid crystal immobilized layer, and heated, and cured with ultraviolet rays under the same conditions as described above to produce a liquid crystal immobilized layer. In this way, by repeating the application in multiple layers until the total thickness reached a desired film thickness, a first region of the optically anisotropic layer was formed.

A difference in refractive index Δn of the cured layer of the composition A-1 was obtained by applying the composition A-1 onto a support with an alignment film for retardation measurement, which was prepared separately, aligning a director of the liquid crystal compound to be parallel to the base material, irradiating the composition A-1 with ultraviolet rays for immobilization to obtain a liquid crystal immobilized layer (cured layer), and measuring a retardation value and a film thickness of the liquid crystal immobilized layer. An could be calculated by dividing the retardation value by the film thickness. The retardation value was measured by measuring a desired wavelength using Axoscan (manufactured by Axometrix inc.) and measuring the film thickness using an SEM.

It was confirmed using a polarization microscope that Δn₅₅₀×thickness(=Re(550)) of the liquid crystal in the first region was finally 180 nm and the first region had the concentric circular liquid crystal alignment pattern as shown in FIG. 7.

In the liquid crystal alignment pattern of the first region, regarding a single period over which the optical axis of the liquid crystal compound rotated by 180°, a single period of a portion at a distance of approximately 5 mm from the center was 4.0 μm; a single period of a portion at a distance of 10 mm from the center was 2.0 μm; a single period of a portion at a distance of 23 mm from the center was 1.0 μm; and the single period decreased toward the outer direction.

In addition, in the first region, a twisted angle of the liquid crystal compound in the thickness direction was 80°.

Hereinafter, unless specified otherwise, the “Δn₅₅₀×thickness” and the like were measured as described above.

### <Formation of Second Region>

A composition A-2 same as the composition A-1 was prepared, except that the chiral agent C-1 was not contained.

A second region of the optically anisotropic layer was formed on the first region in the same manner as the first region, except that the composition A-2 was used.

It was confirmed using a polarization microscope that Δn₅₅₀×thickness(=Re(550)) of the liquid crystal in the second region was finally 365 nm and the second region had the concentric circular liquid crystal alignment pattern as shown in FIG. 7.

In the liquid crystal alignment pattern of the second region, regarding a single period over which the optical axis of the liquid crystal compound rotated by 180°, a single period of a portion at a distance of approximately 5 mm from the center was 4.0 μm; a single period of a portion at a distance of 10 mm from the center was 2.0 μm; a single period of a portion at a distance of 23 mm from the center was 1.0 μm; and the single period decreased toward the outer direction.

In addition, in the second region, a twisted angle of the liquid crystal compound in the thickness direction was 0°.

### <Formation of Third Region>

A composition A-3 same as the composition A-1 was prepared, except that the following chiral agent C-2 was used instead of the chiral agent C-1 and a content of the chiral agent was set to 0.54 parts by mass.

A liquid crystal diffraction element including the optically anisotropic layer consisting of the first region, the second region, and the third region was produced by forming a third region of the optically anisotropic layer on the second region in the same manner as the first region, except that the composition A-3 was used.

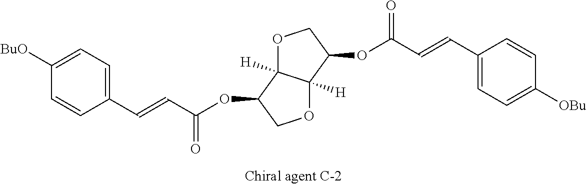

It was confirmed using a polarization microscope that Δn₅₅₀×thickness(=Re(550)) of the liquid crystal in the third region was finally 185 nm and the third region had the concentric circular liquid crystal alignment pattern as shown in FIG. 7.

In the liquid crystal alignment pattern of the third region, regarding a single period over which the optical axis of the liquid crystal compound rotated by 180°, a single period of a portion at a distance of approximately 5 mm from the center was 4.0 μm; a single period of a portion at a distance of 10 mm from the center was 2.0 μm; a single period of a portion at a distance of 23 mm from the center was 1.0 μm; and the single period decreased toward the outer direction. That is, in the present example, the liquid crystal alignment patterns of the respective regions were the same.

In addition, in the third region, a twisted angle of the liquid crystal compound in the thickness direction was −80°.

In a case where a cross section of the optically anisotropic layer was observed with an SEM, bright portions and dark portions were observed as shown in FIG. 10.

In the liquid crystal alignment pattern of the produced optically anisotropic layer, an average period in 50 periods from the longest single period in one direction in which the optical axis of the liquid crystal compound rotated was 25 μm.

A main surface of the liquid crystal diffraction element in a region having a single period equal to or less than the average period was observed with an optical microscope under crossed nicols. The observation was performed such that an absorption axis of one polarizer was parallel to one direction in which an optical axis of the liquid crystal compound in the liquid crystal diffraction element rotated.

Using the direction of the absorption axis of the polarizer parallel to the one direction as the observation direction, among bright lines and dark lines to be observed, a dark line having a width wider than a width of dark lines on both adjacent sides was selected. However, in the liquid crystal diffraction element, the widths of the dark lines were almost uniform, and no dark lines having a width wider than the width of the dark lines on both adjacent sides were found.

That is, it was confirmed that the optically anisotropic layer of the liquid crystal diffraction element had a linear liquid crystal alignment pattern.

### Example 1

In the same manner as in Comparative Example 2, an alignment film was formed on the glass substrate, and the alignment film was exposed to form an alignment film P-1 having an alignment pattern.

### (Formation of Optically Anisotropic Layer)

### <Formation of First Region>

As a liquid crystal composition for forming a first region of the optically anisotropic layer, the following composition B-1 was prepared.

### Composition B-1

| | |
|---|---|
| Liquid crystal compound L-1 | 10.00 parts by mass |
| Liquid crystal compound L-2 | 90.00 parts by mass |
| Chiral agent C-1 | 0.62 parts by mass |
| Polymerization initiator (manufactured by BASF, Irgacure OXE 01) | 1.00 part by mass |
| Leveling agent T-1 | 0.02 parts by mass |
| Leveling agent T-2 | 0.02 parts by mass |
| Methyl ethyl ketone | 1050.00 parts by mass |

Liquid crystal compound L-2 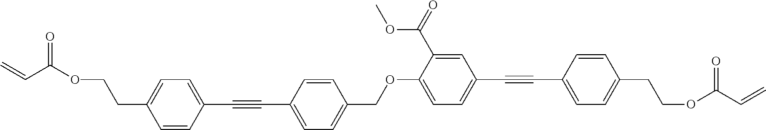 [SMILES: C=CC(=O)OCCc1ccc(C#Cc2ccc(COc3ccc(C#Cc4ccc(CCOC(=O)C=C)cc4)cc3C(=O)OC)cc2)cc1]
Leveling agent T-2

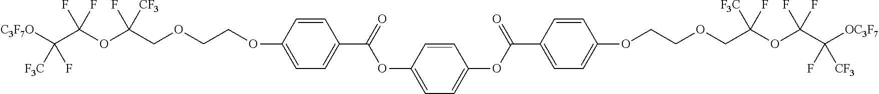

The composition B-1 was applied onto the alignment film P-1 in multiple layers in the same manner as described above, thereby forming a first region of the optically anisotropic layer.

It was confirmed using a polarization microscope that Δn₅₅₀×thickness(=Re(550)) of the liquid crystal in the first region was finally 180 nm and the first region had the concentric circular liquid crystal alignment pattern as shown in FIG. 7.

In the liquid crystal alignment pattern of the first region, regarding a single period over which the optical axis of the liquid crystal compound rotated by 180°, a single period of a portion at a distance of approximately 5 mm from the center was 4.0 μm; a single period of a portion at a distance of 10 mm from the center was 2.0 μm; a single period of a portion at a distance of 23 mm from the center was 1.0 μm; and the single period decreased toward the outer direction.

In addition, in the first region, a twisted angle of the liquid crystal compound in the thickness direction was 80°.

### <Formation of Second Region>

A composition B-2 same as the composition B-1 was prepared, except that the chiral agent C-1 was not contained.

A second region of the optically anisotropic layer was formed on the first region in the same manner as the first region, except that the composition B-2 was used.

It was confirmed using a polarization microscope that Δn₅₅₀×thickness(=Re(550)) of the liquid crystal in the second region was finally 365 nm and the second region had the concentric circular liquid crystal alignment pattern as shown in FIG. 7.

In the liquid crystal alignment pattern of the second region, regarding a single period over which the optical axis of the liquid crystal compound rotated by 180°, a single period of a portion at a distance of approximately 5 mm from the center was 4.0 μm; a single period of a portion at a distance of 10 mm from the center was 2.0 μm; a single period of a portion at a distance of 23 mm from the center was 1.0 μm; and the single period decreased toward the outer direction.

In addition, in the second region, a twisted angle of the liquid crystal compound in the thickness direction was 0°.

### <Formation of Third Region>

A composition B-3 same as the composition B-1 was prepared, except that the chiral agent C-2 was used instead of the chiral agent C-1 and a content of the chiral agent was set to 0.54 parts by mass.

A liquid crystal diffraction element including the optically anisotropic layer consisting of the first region, the second region, and the third region was produced by forming a third region of the optically anisotropic layer on the second region in the same manner as the first region, except that the composition B-3 was used.

It was confirmed using a polarization microscope that Δn₅₅₀×thickness(=Re(550)) of the liquid crystal in the third region was finally 185 nm and the third region had the concentric circular liquid crystal alignment pattern as shown in FIG. 7.

In the liquid crystal alignment pattern of the third region, regarding a single period over which the optical axis of the liquid crystal compound rotated by 180°, a single period of a portion at a distance of approximately 5 mm from the center was 4.0 μm; a single period of a portion at a distance of 10 mm from the center was 2.0 μm; a single period of a portion at a distance of 23 mm from the center was 1.0 μm; and the single period decreased toward the outer direction. That is, in the present example, the liquid crystal alignment patterns of the respective regions were the same.

In addition, in the third region, a twisted angle of the liquid crystal compound in the thickness direction was −80°.

In addition, in a case where a cross section of the optically anisotropic layer was observed with an SEM, dark portions were observed as shown in FIG. 10.

In the liquid crystal alignment pattern of the produced optically anisotropic layer, an average period in 50 periods from the longest single period in one direction in which the optical axis of the liquid crystal compound rotated was 25 μm.

A main surface of the liquid crystal diffraction element in a region having a single period equal to or less than the average period was observed with an optical microscope under crossed nicols. The observation was performed such that an absorption axis of one polarizer was parallel to one direction in which an optical axis of the liquid crystal compound in the liquid crystal diffraction element rotated.

Using the direction of the absorption axis of the polarizer parallel to the one direction as the observation direction, among bright lines and dark lines to be observed, a dark line having a width wider than a width of dark lines on both adjacent sides was randomly selected. In a case where 80 continuous dark lines in the observation direction with the randomly selected dark line as a first dark line were selected and the width of each dark line was checked, it was confirmed that the width of the dark line at an even-numbered position was narrower than the width of the dark line at an odd-numbered position adjacent thereto, and the width of the dark line at an odd-numbered position was wider than the width of the dark line at an even-numbered position adjacent thereto.

That is, it was confirmed that the optically anisotropic layer of the liquid crystal diffraction element had a non-linear liquid crystal alignment pattern.

### Example 2

In the same manner as in Comparative Example 2, an alignment film was formed on the glass substrate, and the alignment film was exposed to form an alignment film P-1 having an alignment pattern.

### (Formation of Optically Anisotropic Layer)

### <Formation of First Region>

As a liquid crystal composition for forming a first region of the optically anisotropic layer, the following composition C-1 was prepared.

### Composition C-1

| | | |
|---|---|---|
| Liquid crystal compound L-3 | 100.00 | parts by mass |
| Chiral agent C-1 | 0.62 | parts by mass |
| Polymerization initiator (manufactured by | 1.00 | part by mass |
| BASF, Irgacure OXE 01) | | |
| Leveling agent T-1 | 0.02 | parts by mass |
| Leveling agent T-2 | 0.02 | parts by mass |
| Methyl ethyl ketone | 1050.00 | parts by mass |

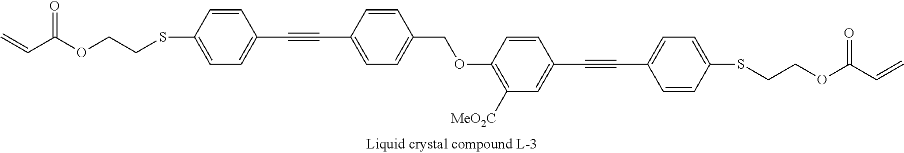 [SMILES: C=CC(=O)OCCSc1ccc(C#Cc2ccc(COc3ccc(C#Cc4ccc(SCCOC(=O)C=C)cc4)cc3C(=O)OC)cc2)cc1]

The composition C-1 was applied onto the alignment film P-1 in multiple layers in the same manner as described above, thereby forming a first region of the optically anisotropic layer.

It was confirmed using a polarization microscope that Δn₅₅₀×thickness(=Re(550)) of the liquid crystal in the first region was finally 180 nm and the first region had the concentric circular liquid crystal alignment pattern as shown in FIG. 7.

In the liquid crystal alignment pattern of the first region, regarding a single period over which the optical axis of the liquid crystal compound rotated by 180°, a single period of a portion at a distance of approximately 5 mm from the center was 4.0 μm; a single period of a portion at a distance of 10 mm from the center was 2.0 μm; a single period of a portion at a distance of 23 mm from the center was 1.0 μm; and the single period decreased toward the outer direction.

In addition, in the first region, a twisted angle of the liquid crystal compound in the thickness direction was 80°.

### <Formation of Second Region>

A composition C-2 same as the composition C-1 was prepared, except that the chiral agent C-1 was not contained.

A second region of the optically anisotropic layer was formed on the first region in the same manner as the first region, except that the composition C-2 was used.

It was confirmed using a polarization microscope that Δn₅₅₀×thickness(=Re(550)) of the liquid crystal in the second region was finally 365 nm and the third region had the concentric circular liquid crystal alignment pattern as shown in FIG. 7.

In the liquid crystal alignment pattern of the second region, regarding a single period over which the optical axis of the liquid crystal compound rotated by 180°, a single period of a portion at a distance of approximately 5 mm from the center was 4.0 μm; a single period of a portion at a distance of 10 mm from the center was 2.0 μm; a single period of a portion at a distance of 23 mm from the center was 1.0 μm; and the single period decreased toward the outer direction.

In addition, in the second region, a twisted angle of the liquid crystal compound in the thickness direction was 0°.

### <Formation of Third Region>

A composition C-3 same as the composition C-1 was prepared, except that the chiral agent C-2 was used instead of the chiral agent C-1 and a content of the chiral agent was set to 0.54 parts by mass.

A liquid crystal diffraction element including the optically anisotropic layer consisting of the first region, the second region, and the third region was produced by forming a third region of the optically anisotropic layer on the second region in the same manner as the first region, except that the composition C-3 was used.

It was confirmed using a polarization microscope that Δn₅₅₀×thickness(=Re(550)) of the liquid crystal in the third region was finally 185 nm and the third region had the concentric circular liquid crystal alignment pattern as shown in FIG. 7.

In the liquid crystal alignment pattern of the third region, regarding a single period over which the optical axis of the liquid crystal compound rotated by 180°, a single period of a portion at a distance of approximately 5 mm from the center was 4.0 μm; a single period of a portion at a distance of 10 mm from the center was 2.0 μm; a single period of a portion at a distance of 23 mm from the center was 1.0 μm; and the single period decreased toward the outer direction. That is, in the present example, the liquid crystal alignment patterns of the respective regions were the same.

In addition, in the third region, a twisted angle of the liquid crystal compound in the thickness direction was −80°.

In a case where a cross section of the optically anisotropic layer was observed with an SEM, bright portions and dark portions were observed as shown in FIG. 10.

In the liquid crystal alignment pattern of the produced optically anisotropic layer, an average period in 50 periods from the longest single period in one direction in which the optical axis of the liquid crystal compound rotated was 25 μm.

A main surface of the liquid crystal diffraction element in a region having a single period equal to or less than the average period was observed with an optical microscope under crossed nicols. The observation was performed such that an absorption axis of one polarizer was parallel to one direction in which an optical axis of the liquid crystal compound in the liquid crystal diffraction element rotated.

Using the direction of the absorption axis of the polarizer parallel to the one direction as the observation direction, among bright lines and dark lines to be observed, a dark line having a width wider than a width of dark lines on both adjacent sides was randomly selected. In a case where 80 continuous dark lines in the observation direction with the randomly selected dark line as a first dark line were selected and the width of each dark line was checked, it was confirmed that the width of the dark line at an even-numbered position was narrower than the width of the dark line at an odd-numbered position adjacent thereto, and the width of the dark line at an odd-numbered position was wider than the width of the dark line at an even-numbered position adjacent thereto.

That is, it was confirmed that the optically anisotropic layer of the liquid crystal diffraction element had a non-linear liquid crystal alignment pattern.

### Comparative Example 3

In the same manner as in Comparative Example 2, an alignment film was formed on the glass substrate, and the alignment film was exposed.

### (Formation of Optically Anisotropic Layer)

### <Formation of First Region>

A first region of the optically anisotropic layer was formed on the alignment film in the same manner as the formation of the second region in Comparative Example 2, except that the film thickness of the optically anisotropic layer was adjusted.

It was confirmed using a polarization microscope that Δn₅₅₀×thickness(=Re(550)) of the liquid crystal in the first region was finally 275 nm and the third region had the concentric circular liquid crystal alignment pattern as shown in FIG. 7.

In the liquid crystal alignment pattern of the first region, regarding a single period over which the optical axis of the liquid crystal compound rotated by 180°, a single period of a portion at a distance of approximately 5 mm from the center was 4.0 μm; a single period of a portion at a distance of 10 mm from the center was 2.0 μm; a single period of a portion at a distance of 23 mm from the center was 1.0 μm; and the single period decreased toward the outer direction.

In addition, in the first region, a twisted angle of the liquid crystal compound in the thickness direction was 0°.

In a case where a cross section of the optically anisotropic layer was observed with an SEM, bright portions and dark portions, such as the second region in the center of FIG. 10, were observed.

In the liquid crystal alignment pattern of the produced optically anisotropic layer, an average period in 50 periods from the longest single period in one direction in which the optical axis of the liquid crystal compound rotated was 25 μm.

A main surface of the liquid crystal diffraction element in a region having a single period equal to or less than the average period was observed with an optical microscope under crossed nicols. The observation was performed such that an absorption axis of one polarizer was parallel to one direction in which an optical axis of the liquid crystal compound in the liquid crystal diffraction element rotated.

Using the direction of the absorption axis of the polarizer parallel to the one direction as the observation direction, among bright lines and dark lines to be observed, a dark line having a width wider than a width of dark lines on both adjacent sides was selected. However, in the liquid crystal diffraction element, the widths of the dark lines were almost uniform, and no dark lines having a width wider than the width of the dark lines on both adjacent sides were found.

That is, it was confirmed that the optically anisotropic layer of the liquid crystal diffraction element had a linear liquid crystal alignment pattern.

### Example 3

In the same manner as in Example 1, an alignment film was formed on the glass substrate, and the alignment film was exposed.

### (Formation of Optically Anisotropic Layer)

### <Formation of First Region>

A first region of the optically anisotropic layer was formed on the alignment film in the same manner as the formation of the second region in Example 1, except that the film thickness of the optically anisotropic layer was adjusted.

It was confirmed using a polarization microscope that Δn₅₅₀×thickness(=Re(550)) of the liquid crystal in the first region was finally 275 nm and the third region had the concentric circular liquid crystal alignment pattern as shown in FIG. 7.

In the liquid crystal alignment pattern of the first region, regarding a single period over which the optical axis of the liquid crystal compound rotated by 180°, a single period of a portion at a distance of approximately 5 mm from the center was 4.0 μm; a single period of a portion at a distance of 10 mm from the center was 2.0 μm; a single period of a portion at a distance of 23 mm from the center was 1.0 μm; and the single period decreased toward the outer direction.

In addition, in the first region, a twisted angle of the liquid crystal compound in the thickness direction was 0°.

In addition, in a case where a cross section of the optically anisotropic layer was observed with an SEM, bright portions and dark portions, such as the second region in the center of FIG. 10, were observed.

In the liquid crystal alignment pattern of the produced optically anisotropic layer, an average period in 50 periods from the longest single period in one direction in which the optical axis of the liquid crystal compound rotated was 25 μm.

A main surface of the liquid crystal diffraction element in a region having a single period equal to or less than the average period was observed with an optical microscope under crossed nicols. The observation was performed such that an absorption axis of one polarizer was parallel to one direction in which an optical axis of the liquid crystal compound in the liquid crystal diffraction element rotated.

Using the direction of the absorption axis of the polarizer parallel to the one direction as the observation direction, among bright lines and dark lines to be observed, a dark line having a width wider than a width of dark lines on both adjacent sides was randomly selected. In a case where 80 continuous dark lines in the observation direction with the randomly selected dark line as a first dark line were selected and the width of each dark line was checked, it was confirmed that the width of the dark line at an even-numbered position was narrower than the width of the dark line at an odd-numbered position adjacent thereto, and the width of the dark line at an odd-numbered position was wider than the width of the dark line at an even-numbered position adjacent thereto.

That is, it was confirmed that the optically anisotropic layer of the liquid crystal diffraction element had a non-linear liquid crystal alignment pattern.

### Example 4

In the same manner as in Example 1, an alignment film was formed on the glass substrate, and the alignment film was exposed.

### (Formation of Optically Anisotropic Layer)

### <Formation of First Region>

A first region of the optically anisotropic layer was formed on the alignment film in the same manner as in the formation of the first region of Example 1, except that the content of the chiral agent C-1 of the composition B-1 was changed.

It was confirmed using a polarization microscope that Δn₅₅₀×thickness(=Re(550)) of the liquid crystal in the first region was finally 180 nm and the first region had the concentric circular liquid crystal alignment pattern as shown in FIG. 7.

In the liquid crystal alignment pattern of the first region, regarding a single period over which the optical axis of the liquid crystal compound rotated by 180°, a single period of a portion at a distance of approximately 5 mm from the center was 4.0 μm; a single period of a portion at a distance of 10 mm from the center was 2.0 μm; a single period of a portion at a distance of 23 mm from the center was 1.0 μm; and the single period decreased toward the outer direction.

In addition, in the first region, a twisted angle of the liquid crystal compound in the thickness direction was 85°.

### <Formation of Second Region>

A second region of the optically anisotropic layer was formed on the first region in the same manner as in the formation of the first region of Example 1, except that the content of the chiral agent C-1 of the composition B-1 was changed to change the film thickness.

It was confirmed using a polarization microscope that Δn₅₅₀×thickness(=Re(550)) of the liquid crystal in the second region was finally 365 nm and the second region had the concentric circular liquid crystal alignment pattern as shown in FIG. 7.

In the liquid crystal alignment pattern of the second region, regarding a single period over which the optical axis of the liquid crystal compound rotated by 180°, a single period of a portion at a distance of approximately 5 mm from the center was 4.0 μm; a single period of a portion at a distance of 10 mm from the center was 2.0 μm; a single period of a portion at a distance of 23 mm from the center was 1.0 μm; and the single period decreased toward the outer direction.

In addition, in the second region, a twisted angle of the liquid crystal compound in the thickness direction was 13°.

### <Formation of Third Region>

A liquid crystal diffraction element including the optically anisotropic layer consisting of the first region, the second region, and the third region was produced by forming the third region of the optically anisotropic layer on the second region in the same manner as in the formation of the third region of Example 1, except that the content of the chiral agent C-2 of the composition B-3 was changed.

It was confirmed using a polarization microscope that Δn₅₅₀×thickness(=Re(550)) of the liquid crystal in the third region was finally 185 nm and the third region had the concentric circular liquid crystal alignment pattern as shown in FIG. 7.

In the liquid crystal alignment pattern of the third region, regarding a single period over which the optical axis of the liquid crystal compound rotated by 180°, a single period of a portion at a distance of approximately 5 mm from the center was 4.0 μm; a single period of a portion at a distance of 10 mm from the center was 2.0 μm; a single period of a portion at a distance of 23 mm from the center was 1.0 μm; and the single period decreased toward the outer direction. That is, in the present example, the liquid crystal alignment patterns of the respective regions were the same.

In addition, in the third region, a twisted angle of the liquid crystal compound in the thickness direction was −73°.

In addition, in a case where a cross section of the optically anisotropic layer was observed with an SEM, a pattern of bright portions and dark portions was observed.

In the liquid crystal alignment pattern of the produced optically anisotropic layer, an average period in 50 periods from the longest single period in one direction in which the optical axis of the liquid crystal compound rotated was 25 μm.

A main surface of the liquid crystal diffraction element in a region having a single period equal to or less than the average period was observed with an optical microscope under crossed nicols. The observation was performed such that an absorption axis of one polarizer was parallel to one direction in which an optical axis of the liquid crystal compound in the liquid crystal diffraction element rotated.

Using the direction of the absorption axis of the polarizer parallel to the one direction as the observation direction, among bright lines and dark lines to be observed, a dark line having a width wider than a width of dark lines on both adjacent sides was randomly selected. In a case where 80 continuous dark lines in the observation direction with the randomly selected dark line as a first dark line were selected and the width of each dark line was checked, it was confirmed that the width of the dark line at an even-numbered position was narrower than the width of the dark line at an odd-numbered position adjacent thereto, and the width of the dark line at an odd-numbered position was wider than the width of the dark line at an even-numbered position adjacent thereto.

That is, it was confirmed that the optically anisotropic layer of the liquid crystal diffraction element had a non-linear liquid crystal alignment pattern.

### [Evaluation]

### <Ability of Cutting Zeroth-Order Ray>

In a case where the dextrorotatory polarized light having an ellipticity sin of 0.95 or more (0.99) and the levorotatory polarized light having an ellipticity sin of 0.95 or more (0.99) were respectively incident from the front surface (direction with an angle of 0° with respect to a normal line) at a position of approximately 5 mm from the center of the liquid crystal lens of Comparative Example 1 and the center of the produced liquid crystal diffraction element, an intensity of incidence ray and an intensity of zeroth-order ray among emitted light from the polarization diffraction element were measured with a photodetector, and an amount of the zeroth-order ray (amount of zeroth-order ray in a case where the amount of incidence ray was set to 1) was calculated by the following expression.

$$Amount of zeroth - order ray ( A ) = Intensity of zeroth - order ray / Intensity of incidence ray$$

An average value (zeroth-order LL(A)) of the amounts of the zeroth-order ray in a case where the above-described dextrorotatory polarized light having an ellipticity sin of 0.95 or more (0.99) and the above-described levorotatory polarized light having an ellipticity sin of 0.95 or more (0.99) were respectively incident was calculated.

Next, in the above-described evaluation, a circularly polarizing plate (λ/4 plate: WPQSM05-532 manufactured by Thorlabs, Inc.; linearly polarizing plate: SPF-50C-32 manufactured by Sigma Koki Co., Ltd.) was disposed on the downstream side of the liquid crystal lens of Comparative Example 1 and the produced liquid crystal diffraction element in the front surface of the zeroth-order ray (direction with an angle of 0° with respect to a normal line). In this case, the circularly polarizing plate was disposed such that it transmitted levorotatory circularly polarized light and absorbed dextrorotatory circularly polarized light. The dextrorotatory polarized light having an ellipticity sin of 0.95 or more (0.99) and the levorotatory polarized light having an ellipticity sin of 0.95 or more (0.99) were respectively incident, an intensity of incidence ray and an intensity of zeroth-order ray emitted from the circularly polarizing plate were measured with a photodetector, and an amount of the zeroth-order ray was calculated by the following expression.

$$Amount of zeroth - order ray ( B ) = Intensity of zeroth - order ray / Intensity of incidence ray$$

An average value (zeroth-order LL(B)) of the amounts of the zeroth-order ray in a case where the above-described dextrorotatory polarized light having an ellipticity εin of 0.95 or more (0.99) and the above-described levorotatory polarized light having an ellipticity sin of 0.95 or more (0.99) were respectively incident was calculated.

The zeroth-order LL(A) in a case where the circularly polarizing plate was not provided was compared with the zeroth-order LL(B) in a case where the circularly polarizing plate was provided. As a result, in Examples 1, 2, and 4, the ability of cutting the zeroth-order ray of the circularly polarizing plate was high, and light leakage of the zeroth-order ray from the circularly polarizing plate could be suppressed, as compared with Comparative Examples 1 and 2. Similarly, in Example 3, the ability of cutting the zeroth-order ray of the circularly polarizing plate was also high as compared with Comparative Example 3.

The light leakage of the zeroth-order ray was evaluated in the same manner at the position of approximately 10 mm from the center of the liquid crystal lens of Comparative Example 1 and the produced liquid crystal diffraction element.

The zeroth-order LL(A) in a case where the circularly polarizing plate was not provided was compared with the zeroth-order LL(B) in a case where the circularly polarizing plate was provided. As a result, in Examples 1, 2, and 4, the ability of cutting the zeroth-order ray of the circularly polarizing plate was high, and light leakage of the zeroth-order ray from the circularly polarizing plate could be suppressed, as compared with Comparative Examples 1 and 2. Similarly, in Example 3, the ability of cutting the zeroth-order ray of the circularly polarizing plate was also high as compared with Comparative Example 3.

The light leakage of the zeroth-order ray was evaluated in the same manner at the position of approximately 23 mm from the center of the produced liquid crystal diffraction element.

The zeroth-order LL(A) in a case where the circularly polarizing plate was not provided was compared with the zeroth-order LL(B) in a case where the circularly polarizing plate was provided. As a result, in Examples 1, 2, and 4, the ability of cutting the zeroth-order ray of the circularly polarizing plate was high, and light leakage of the zeroth-order ray from the circularly polarizing plate could be suppressed, as compared with Comparative Example 2. In Example 4, the ability of cutting the zeroth-order ray of the circularly polarizing plate was higher than that in Example 1.

In addition, in the polarization diffraction element produced in Example 2, in a case where the incidence positions of light were changed to 5 mm, 10 mm, and 23 mm from the center of the element, the polarization state of the zeroth-order ray changed depending on the incidence position of light, and the difference in ellipticity εin−ε0 between the incident polarized light and the zeroth-order ray changed. In addition, an absolute value Abs (Δε(LH)−Δε(RH)) of the difference between the difference Δε(RH) between the ellipticities of the incidence ray and the zeroth-order ray in a case where the dextrorotatory polarized light was incident and the difference Δε(LH) between the difference between the ellipticities of the incidence ray and the zeroth-order ray in a case where the levorotatory polarized light was incident increased as the incidence position of light moved away from the center of the element (5 mm→10 mm→23 mm), and at each incidence position of light, in a case where the zeroth-order LL(A) in a case where the circularly polarizing plate was not provided was compared with the zeroth-order LL(B) in a case where the circularly polarizing plate was provided, the ability of cutting the zeroth-order ray of the circularly polarizing plate was improved.

In addition, in the liquid crystal diffraction element produced in Example 4, in a case where the incidence positions of light were changed to 5 mm, 10 mm, and 23 mm from the center of the element, the polarization state of the zeroth-order ray changed depending on the incidence position of light, and the difference in ellipticity εin−ε0 between the incident polarized light and the zeroth-order ray changed. In addition, an absolute value Abs(Δε(LH)−Δε(RH)) of the difference between the difference Δε(RH) between the ellipticities of the incidence ray and the zeroth-order ray in a case where the dextrorotatory polarized light was incident and the difference Δε(LH) between the difference between the ellipticities of the incidence ray and the zeroth-order ray in a case where the levorotatory polarized light was incident increased as the incidence position of light moved away from the center of the element (5 mm→10 mm→23 mm), and at each incidence position of light, in a case where the zeroth-order LL(A) in a case where the circularly polarizing plate was not provided was compared with the zeroth-order LL(B) in a case where the circularly polarizing plate was provided, the ability of cutting the zeroth-order ray of the circularly polarizing plate was improved. In Example 4, compared to Example 2, the change in Abs(Δε(LH)−Δε(RH)) and the change in the ability of cutting the zeroth-order ray of the circularly polarizing plate were large in a case where the incidence position of light was changed from 10 mm to 23 mm, and the ability of cutting the zeroth-order ray of the circularly polarizing plate was high at 23 mm.

### <Liquid Crystal Alignment Pattern>

The liquid crystal diffraction elements of Examples 1 to 4, the liquid crystal lens of Comparative Example 1, and the liquid crystal diffraction elements of Comparative Examples 2 and 3 were observed with an optical microscope, and observation images were captured.

In the obtained 8-bit (256 gradations) captured image, the image was binarized using an average value of the brightest gradation and the darkest gradation as a threshold value, and widths of 80 continuous dark lines were measured in the same manner as described above.

A case where the following expression was satisfied was evaluated as A, and a case where the following expression was not satisfied was evaluated as B.

$$[ Average of widths of dark lines at odd - numbered positions ] - [ \text{} Average of widths of dark lines at even - numbered positions ] > ( [ Standard deviation of widths of dark lines at odd \text{} - numbered positions ] + [ Standard deviation of widths of dark lines at even - numbered positions ] ) / 2$$

As a result, all of Examples 1 to 4 were A, and all of Comparative Examples 1 to 3 were B.

From the above results, the effect of the present invention is clear.

The present invention can be suitably used for various devices such as an optical device, for example, a head-mounted display and a virtual reality display device.

### EXPLANATION OF REFERENCES

10: liquid crystal diffraction element
30: support
32: alignment film
36, 36A, 36B, 36C, 36S, 36Z: optically anisotropic layer
40: liquid crystal compound
40A: optical axis
42: bright portion
44: dark portion
60: exposure device
62: laser
64: light source
65: λ/2 plate
68: beam splitter
70A, 70B, 90A, 90B: mirror
72A, 72B, 96: λ/4 plate
86, 94: polarization beam splitter
92: lens
o: dark line (odd-numbered position)
e: dark line (even-numbered position)
Λ: single period
D: arrangement axis
R: region
M: laser light
MA, MB: ray
MP: P polarized light
MS: S polarized light
P_{O}: linearly polarized light
P_{R}: dextrorotatory circularly polarized light
P_{L}: levorotatory circularly polarized light
α: intersecting angle
L₁, L₄: incidence ray
L₂, L₅: transmitted ray

What is claimed is:

1. A liquid crystal diffraction element comprising:
an optically anisotropic layer formed of a liquid crystal composition containing a liquid crystal compound;
wherein the optically anisotropic layer has a liquid crystal alignment pattern in which an orientation of an optical axis derived from the liquid crystal compound changes while continuously rotating in at least one in-plane direction, and
in a case where a length in the liquid crystal alignment pattern, over which the orientation of the optical axis derived from the liquid crystal compound rotates by 180° in a plane, is set as a single period, an average period in 50 periods from a single period having a longest length along the one direction is defined as Λa, a main surface of the optically anisotropic layer is observed with an optical microscope under crossed nicols in a region having a single period equal to or less than the average period Λa, in a state in which the optically anisotropic layer is disposed such that an absorption axis of a polarizer constituting the crossed nicols is parallel to the one direction, and using the absorption axis of the polarizer, parallel to the one direction, as an observation direction, in observed bright lines and dark lines, a dark line having a width wider than a width of dark lines on both adjacent sides is randomly selected, and 80 continuous dark lines are selected with the randomly selected dark line as a first dark line,
in the selected 80 continuous dark lines in the observation direction, a width of a dark line at an even-numbered position is narrower than a width of a dark line at an odd-numbered position, which is adjacent to the dark line at an even-numbered position, and a width of a dark line at an odd-numbered position is wider than a width of a dark line at an even-numbered position, which is adjacent to the dark line at an odd-numbered position.

2. The liquid crystal diffraction element according to claim 1,
wherein the selected 80 continuous dark lines satisfy the following expression,
$$[ average of widths of dark lines at odd - numbered positions ] - [ \text{} average of widths of dark lines at even - numbered positions ] > ( [ standard deviation of widths of dark lines at odd - numbered positions ] + [ \text{} standard deviation of widths of dark lines at even - numbered positions ] ) / 2.$$

3. The liquid crystal diffraction element according to claim 1,
wherein the liquid crystal alignment pattern is a concentric circular pattern that has the one direction in which the orientation of the optical axis derived from the liquid crystal compound changes while continuously rotating, in a concentric circular shape from an inner side toward an outer side.

4. The liquid crystal diffraction element according to claim 2,
wherein the liquid crystal alignment pattern is a concentric circular pattern that has the one direction in which the orientation of the optical axis derived from the liquid crystal compound changes while continuously rotating, in a concentric circular shape from an inner side toward an outer side.
